(19) United States
(12) Patent Application Publication
(10) Pub. No.: US 2022/0396880 A1
(43) Pub. Date: Dec. 15, 2022

(54) MICROWAVE-ASSISTED APPARATUS, SYSTEM AND METHOD FOR DEPOSITION OF FILMS ON SUBSTRATES

(71) Applicants: Indian Institute of Science, Bengaluru (IN); Indian Space Research Organization Headquarters, Bengalura (IN)

(72) Inventors: Ranajit Sai, Bengaluru (IN); Srinivasarao Ajjampur Shivshankar, Bengaluru (IN); Kumar Hooda Manish, Nagar (IN)

(21) Appl. No.: 17/773,612

(22) PCT Filed: Nov. 2, 2020
(86) PCT No.: PCT/IN2020/050923

§ 371 Date: May 1, 2022

(30) Foreign Application Priority Data
Oct. 31, 2019 (IN) 201941044241

(51) Int. Cl. C23C 18/14; C23C 18/12

(52) U.S. Cl. CPC C23C 18/14; C23C 18/1204; C23C 18/1241; C23C 18/1245

(57) ABSTRACT

The present invention provides an apparatus for the deposition of thin films on a substrate, including large substrates, held preferably face-down, in a cartridge containing a liquid solution with at least a chemical precursor which, upon being subject to a uniform microwave field transmitted through a microwave-transparent window, leads to the formation of a thin film on the substrate. The present invention also provides a system for launching microwaves and controlling the process for film deposition on the substrate. The present invention also provides a process for obtaining a film of uniform thickness and characteristics on a substrate or for incorporating controlled non-uniformity. The present invention also provides an apparatus and method for film deposition on a series of substrates in a continuous batch process.

### TECHNICAL FIELD

The subject matter of the present invention relates to an apparatus, system and a process for the deposition of films on a substrate in a microwave-assisted environment, in a liquid medium.

The deposition of thin film on a substrate is performed through various methods, including thermal evaporation, sputtering, chemical vapour deposition (CVD), electroplating, sol-gel etc. However, crystalline films of certain technologically important refractory materials (e.g., ferrites, perovskites) cannot be deposited by these known methods, particularly at a temperature of 600° C., making such methods CMOS-incompatible. In addition, the field of flexible electronics also demands a low-temperature processing. In order to overcome the stated problems, the processes that are based on microwave-assisted systems (MAS) can be used. However, in MAS-based systems and methods, the substrate or a surface that is to be coated, is immersed in a precursor solution, in a random orientation, thereby preventing microwave field intensity from being uniform across the surface of the substrate. In addition, in such devices/systems, where the deposition chamber and the microwave cavity are the same, result in a contamination (due to the deposition process) of the microwave cavity, which can adversely affect the microwave field distribution not only in the solution but also across the surface of the substrate.

In the known art, microwave-generated plasmas are used for the deposition of thin films as well as for the surface treatment of a substrate (e.g. U.S. Pat. No. 4,265,730A, JPS62218575A, U.S. Pat. Nos. 5,389,197A, 5,556,475A). Microwave plasma reactors typically include a vacuum chamber containing a gas to be energized to form the plasma. Microwave energy is introduced to the chamber through a dielectric window or dielectric barrier to maintain the vacuum in the processing chamber while providing a means of allowing the microwave energy to enter the chamber. Such dielectric windows are susceptible to corrosion from the exposure to the generated plasma. In addition, the need to maintain a fairly low pressure (of the order of millitorr) inside the reactor renders the apparatus cumbersome to make, and expensive and complicated to operate. Moreover, such reactors are meant for gases and not for liquids or liquid solutions of any kind. Furthermore, the deposition of thins films (coatings) in a microwave plasma leads to the bombardment of the film/substrate by energetic charged particles, which can cause damage to the film or introduce defects in them. In addition, films deposited with microwave plasma assistance generally require annealing at elevated temperatures to make the deposited films crystalline. Such annealing would not be compatible with low-temperature processing in general, and CMOS processing in particular.

A microwave-dielectric heating principle for the synthesis of peptide and for analytical sample preparation, is disclosed in U.S. Pat. No. 7,282,184B2 and U.S. Ser. No. 10/390,388B2. However, such microwave synthesis handles liquid samples for digestion, and the related apparatus generally features non-uniform microwave field intensity over a large volume, say 10000 cc. Specifically, such equipment are not meant for handling solid substances, such as a large substrate (up to 300 mm in extension) to be coated with a film of thickness that is uniform across the substrate surface.

U.S. Pat. No. 6,867,400B2 discloses a continuous flow (chemical) synthesis by using microwave irradiation. The apparatus meant for such synthesis provides a tiny inlet and a tiny outlet line for the liquids involved to pass through the microwave cavity. However, the cavity size is very small, capable of handling only a spectroscopic flow cell. Deposition of a thin film on a large substrate is not possible in such an apparatus.

In the known art, there is also a limitation of dynamic or static movement of microwave ports that in turn prevents required manipulation of the microwave fields emitting from the ports and thus fails to create a uniform microwave field intensity over a large area.

The MAS process that is known in the art also involves irradiation of a precursor solution (in which a substrate is immersed) that is placed within the microwave cavity. As a result, the vapours of the solution, which are generated during the irradiation, fill the microwave cavity or chamber, causing the inner (electrically conducting) walls of the microwave cavity to be coated with a non-conducting layer. This coating can alter the microwave field distribution in the microwave cavity, affecting the MAS process, i.e., altering the uniformity of film thickness across the substrate, the uniformity of film composition across the substrate, and altering the rate of deposition. Thus, the known MAS process also has a limitation in achieving “clean conditions” usually required during the course of deposition of a substrate that is used for semiconductor device fabrication.

### Objects of the Present Invention

Accordingly, the primary object of the present invention is to provide an apparatus for the deposition of films on a substrate, including a large substrate, using microwave-assisted chemical reactions in a liquid medium.

An object of the present invention is to provide an apparatus for deposition of a film on a substrate, with a configuration of a physically separated substrate cartridge chamber and an applicator (microwave applicator).

Another object of the present invention is to provide an apparatus for deposition of films on large substrates, to obtain films with uniform thickness and composition across the substrate surface.

Yet another object of the present invention is to provide a to provide an apparatus for the deposition of a film on a substrate, with the substrate positioned in a face-down configuration.

One more object of the present invention is to provide an apparatus for attaining and controlling uniformity in the strength of the microwave field needed for the deposition of a uniform thin film.

It is also an object of the present invention is to provide an apparatus for deposition of a film on a substrate, to exercise a control over the formation of nucleation density on a substrate.

Yet another object of the present invention is to provide an apparatus for the deposition of patterned films and coatings on selected areas of a substrate, in a single step.

One other object of the present invention is to provide an apparatus for depositing a film on both sides of a substrate simultaneously.

It is also an object of the present invention to provide an apparatus to deposit a film with a gradient in thickness and composition across the surface of a substrate.

Yet another object of the present invention is to provide an apparatus to control the polarization of the microwave field during film deposition, either dynamically or statically, using a suitable static or rotating metallic layer(s).

A further object of the present invention is to provide an apparatus for deposition of films on substrates in a batch process.

It is also an object of the present invention is to provide a system and a process for the deposition of films on a substrate including a large substrate, using microwave-assisted chemical reactions in a liquid medium.

### SUMMARY OF THE INVENTION

The present invention provides an apparatus for the deposition of thin films on a substrate, held preferably face-down, in a cartridge containing a liquid with at least a chemical precursor which, upon being subject to a uniform microwave field transmitted through a microwave-transparent window, leads to the formation of a thin film on the substrate. The present invention also provides a system for launching microwaves and controlling the process for film deposition on the substrate. The present invention also provides a process for obtaining a film of uniform thickness and characteristics on a substrate or for incorporating controlled non-uniformity. The present invention also provides an apparatus and method for film deposition on a series of substrates in a continuous batch process.

### BRIEF DESCRIPTION OF DRAWINGS

FIG. 1(a) is a sectional schematic representation of an apparatus of the present invention, depicting a physical separation of a substrate cartridge chamber from an applicator.

FIG. 1(b) is schematic top views of a microwave-transparent lid of the substrate cartridge chamber.

FIG. 1(c) is a schematic sectional representation of the substrate cartridge chamber, depicting a film that is deposited on the substrate.

FIG. 1(d) is a schematic sectional exploded view of the substrate cartridge with a substrate.

FIG. 2 is a schematic sectional view depicting an arrangement of the substrate cartridge chamber inside the applicator.

FIG. 3(a) is a schematic sectional view depicting an arrangement of ports in the applicator, along with respective microwave generating units (MGUs).

FIG. 3(b) is a schematic sectional view depicting exemplary positional arrangement of ports, along with the respective microwave generation units in the applicator.

FIG. 3(c) is a schematic top view arrangement of ports, along with respective microwave generation units in the applicator.

FIG. 4 is a schematic sectional view of the apparatus, depicting means for controlling ambient conditions in the applicator.

FIG. 5 is a schematic sectional view of the apparatus, depicting an arrangement of transmitter-receiver assembly for in situ characterization and measurement of thickness of the film deposited on the substrate.

FIG. 6 is a schematic sectional view of the apparatus, depicting walls of the substrate cartridge chamber coated with a microwave-absorbing material.

FIG. 7 is a schematic sectional view of the apparatus, illustrating a vertical movement of the substrate cartridge.

FIGS. 8(a-b) is a schematic sectional view of the apparatus, depicting an arrangement for the vertical and pulsed-vertical movement (z-axis movement) of the cartridge.

FIG. 8(c) is a schematic sectional view of the apparatus, depicting an arrangement of substrate in surface contact with a liquid in the microwave transparent container.

FIG. 8(d) is a schematic sectional view of the apparatus, with an arrangement for the rotational movement of the substrate cartridge.

FIG. 8(e) is a schematic sectional view of the meshing arrangement illustrating the rotation of the removable lid.

FIG. 9 is a schematic sectional view of the cartridge of the apparatus, depicting an arrangement of varying column height of the liquid inside the microwave-transparent container i.e., a z-axis movement.

FIG. 10 is a schematic sectional view of the cartridge of the apparatus, depicting a gradient arrangement of the substrate.

FIG. 11 is a schematic sectional view of the cartridge of the apparatus, depicting an arrangement for a two-side coating of a substrate.

FIG. 12(a) is a schematic sectional view of the cartridge of the apparatus, depicting the lid with an electrically conducting metallic layer.

FIG. 12(b) is a schematic sectional and top view of the cartridge of the apparatus, depicting a patterned electrically conducting metallic layer.

FIG. 13(a) is schematic sectional view of the apparatus, depicting an arrangement of electrically conducting metallic layer on the microwave-transparent window of the applicator.

FIG. 13(b) is a schematic top view of the electrically conducting metal layer that is arranged on the microwave-transparent window of the applicator.

FIG. 14 is a schematic sectional view of the apparatus depicting an arrangement of microwave-transparent container without the microwave transparent window.

FIG. 15 is a schematic sectional view depicting an apparatus for batch processing of substrates.

FIG. 16 is a broad system architecture using the apparatus of the present invention for the deposition of thin films and coatings on a substrate.

FIG. 17 is a schematic drawing depicting gas injection means of the system of the present invention.

FIG. 18 is a schematic drawing depicting vacuum control means of the system of the present invention.

FIG. 19(a-e) are flow drawings providing the steps for the process for the deposition of films on at least a substrate.

FIG. 20 is across-sectional SEM image of a thick and uniform zinc ferrite film on Si/BPSG substrate.

FIG. 21 is across-sectional SEM image of a thick but non-uniform nickel ferrite film on a silicon substrate.

FIG. 22 is across-sectional SEM image of a thick and uniform manganese-zinc ferrite on a Si/BPSG substrate.

FIG. 23 is across-sectional SEM image of a small piece of a scratched zinc ferrite film out of a silicon substrate showing the film surface that was in contact with the substrate.

FIG. 24 is the cross-sectional SEM images of two smooth and uniform film of (a) zinc ferrite and (b) nickel ferrite deposited on silicon substrate.

FIG. 25 is a photograph of a piece of silicon substrate deposited with zinc ferrite film of gradient thickness.

FIG. 26 is a SEM image of a thick two-layered film of zinc ferrite on silicon substrates depicting two-step deposition processing in sequence after replenishing the reacting liquid at the end of the first step.

FIG. 27 is a top view of SEM image of the backside of a silicon substrate deposited with a nickel ferrite film simultaneously with the front side.

FIG. 28 is a top view SEM image of zinc ferrite film deposited selectively on a 2 μm thick polyamide layer, wherein a patterned Al metal layer is situated underneath the polyamide layer, exhibiting that the deposited ferrite film has followed the Al metal pattern.

### DETAILED DESCRIPTION OF THE INVENTION

Preferred embodiments of the present invention will be described in detail with reference to the attached drawings. It is to be understood that the present invention is not limited to specific configurations of the apparatus, system and process steps as described in the following embodiments, but also includes configurations and steps in accordance with the same technological endeavour.

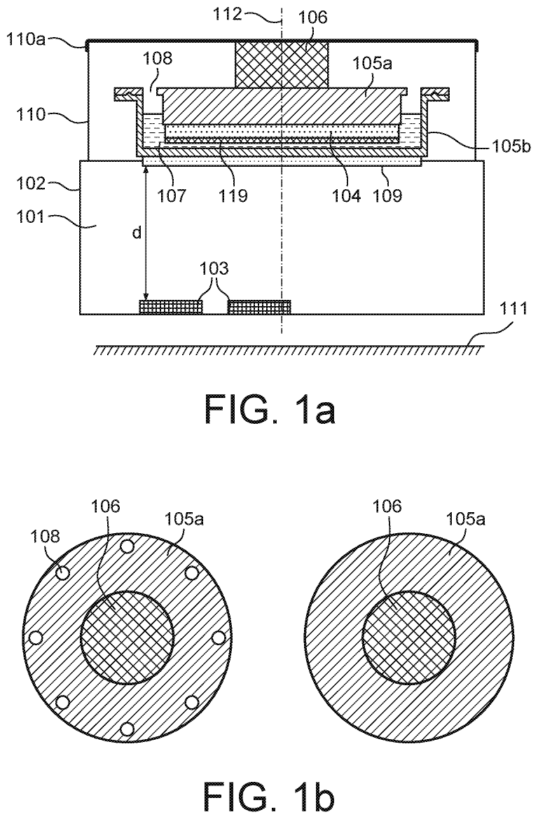

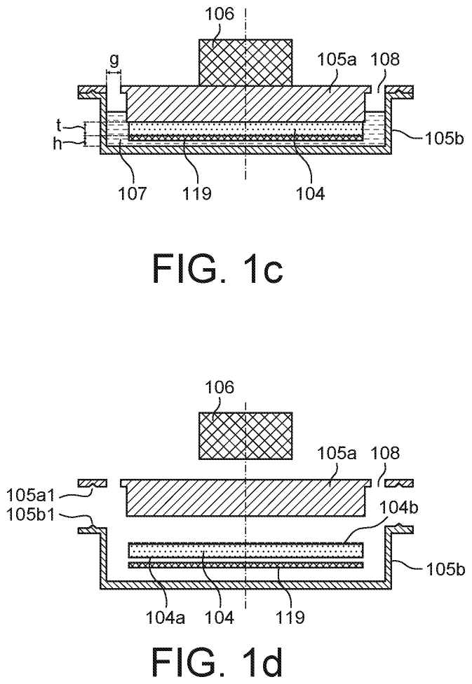

FIG. 1(a) depicts a configuration of the apparatus 100, in accordance with an embodiment of the present invention.

As shown in FIG. 1(a), the apparatus 100 is configured to deposit a thin film and coatings on a substrate 104.

An applicator 101, acts as a first chamber and is made of suitable material that can exhibit characteristics such as microwave reflection, electrical conductivity and non-magnetism. In this invention, advantageously, materials such as stainless steel, aluminium, etc., are used to form the applicator 101. In this illustrative embodiment, the apparatus 100 is shown to be rectangular in cross-section, which is a non-limiting factor and other suitable shapes, can be suitably adapted for use. An array of ports 103 is formed on the base portion of the applicator 101 and are connected to MGUs (not shown in FIG. 1(a)), to receive microwave energy into the applicator 101. The ports, each of which is connected to a MGU, are arranged in selected positions, in such a manner, to direct microwave energy from the MGUs into the applicator 101. The microwave energy thus received by the applicator 101 is channelized and propagated upwards from the MGUs towards the substrate cartridge chamber (SCC). As window 109 microwave-transparent, all the microwave energy incident on it is transmitted into the SCC, because of which a microwave field is set up in the SCC. The strength and uniformity of this field is “tuned” as desired, in the manner described hereunder.

The base plane 111 or the base axis is the horizontal plane that forms the “bottom” of the apparatus 100. It is in reference to the plane 111 that MGUs are arranged in desired vertical offsets, so as to obtain the microwave field strength and uniformity in the SCC that is desired.

A microwave-transparent window 109 is arranged on an upper portion of the applicator 101. Peripheral edges of the microwave-transparent window 109 are suitably connected or fused to peripheral edges of the upper portion of the applicator 101, as shown in FIG. 1(a), such that the the microwave-transparent window 109 is connected to upper portion of the applicator 101 through a suitable seal that allows the maintenance of a sub-atmospheric pressure or a pressure exceeding that of the atmosphere in the applicator and/or the SCC. Such a seal may be a suitably shaped gasket, as is well known in the art. The microwave-transparent window 109 is configured to be permit transmission of microwaves, infrared (IR) waves ultraviolet (UV) waves and visible light, so that thickness of the film or coatings on the substrate can be monitored during the course of its formation. In this illustrative embodiment, the preferred material that is used for the microwave-transparent window 109 is fused quartz. The microwave-transparent window 109 can be also made from materials such as polytetrafluoroethylene (PTFE) or sapphire (single-crystalline aluminium oxide) or borosilicate/Pyrex glass. The applicator 101 along with the microwave-transparent window 109 and the array of ports 103, forms a single sealed unit, to receive and propagate the microwave energy. The applicator 101 is also configured to maintain desired sub-atmospheric pressure conditions or a pressure above that of the atmosphere, as hereinafter described.

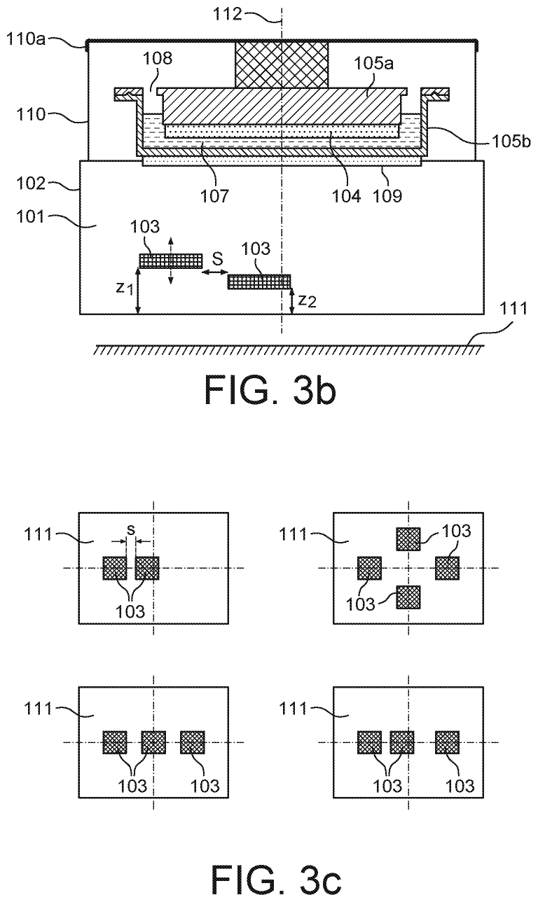

The distance between the array of ports 103 and the microwave-transparent window 109, is shown as “d”, in FIG. 1(a). The distance “d” is either constant or variable. The strength of the microwave field in the SCC depends on “d”. The strength and the uniformity of the field depend on “d” as well as on the vertical displacement of the array of ports 103 relative to the plane 111, as depicted in FIG. 3(b). They also depend on their relative placement in the horizontal projection, as depicted schematically in FIG. 3(c). These placements are determined through computations based on electromagnetic theory so that the desired strength and uniformity of the microwave field is obtained in the liquid column 107 and the substrate surface 104a. In other words, by altering the spacings in between or among the array of ports 103 and by stationing one port in a vertically offset position with respect to the other it is possible to make the emitting microwaves out of the array of ports 103 in-phase or out-of-phase or in between, and thus combining the microwaves suitably as per the requirements. Accordingly, the distance “d” is consistent with the requirement of field uniformity and field strength (intensity).

A substrate cartridge chamber 110 with a removable cover 110a is mounted on the applicator 101 as shown in FIG. 1(a). The removable cover 110a is connected to the substrate cartridge chamber 110, through an appropriate seal, such as a gasket arrangement, so as to maintain a sub-atmospheric ambient inside.

The mounting of substrate cartridge chamber 110 on the applicator 101 is such that substrate cartridge chamber 110 is physically separable from the applicator 101. The substrate cartridge chamber 110 is mounted on the applicator 101, along with a gasket, so that it allows a sub-atmospheric pressure or a pressure above that of the atmosphere can be maintained in the substrate cartridge chamber 110.

The substrate cartridge chamber 110 is mounted on the applicator 101 in a manner that a part of the bottom portion is exposed to the microwave-transparent window 109. In other words, the microwave-transparent window 109 is anchored to the edges of the upper portion of the applicator 101 and to the edges of the bottom portion of the substrate cartridge chamber 110. The substrate cartridge chamber 110 is connected to the upper portion of the applicator 101 and is physically isolated from the applicator 101. The microwaves are permitted into the substrate cartridge chamber 110 through the microwave-transparent window 109. The MGU(s) 103a are connected to the apparatus 100 through the array of ports 103 in such a configuration that the microwave field generated is as uniform as possible in the (X-Y) plane perpendicular to the vertical Z axis 112 of the apparatus 100 near the microwave transparent window 109. This is achieved by modelling the microwave field as a function of the number of MGUs, their power and their (XYZ) coordinates. The rendering of uniform microwave field in the X-Y plane inside the applicator 101, is carried forward into the substrate cartridge chamber 110. A high degree of permeation of the microwave field from the applicator 101 into the substrate cartridge chamber 110, through the microwave-transparent window 109, enables the presence of a strong microwave field inside the substrate cartridge chamber 110.

Therefore, in the above-stated constructional arrangement, the substrate cartridge chamber 110 is connected to the upper portion of the applicator 101 and is physically isolated from the applicator 101. Such physical separation enables the maintenance of the desired gaseous ambient in 110 that may be required for chemical reactions to occur in the liquid in the cartridge. In addition, clean conditions in the substrate cartridge chamber 110, are also enabled, which are needed for the deposition of thin films, for instance, as a part of the fabrication of integrated circuits.

The substrate cartridge chamber 110 is made of suitable material that can exhibit characteristics such as microwave reflection, electrical conductivity and non-magnetism. In this invention, advantageously, materials such as stainless steel, aluminum etc., are used to form the substrate cartridge chamber 110. The shape and size of the substrate cartridge chamber 110 is suitably selected considering inter alia, the size of the substrate.

A microwave-transparent container 105b, which is exemplarily shown as a dish, is advantageously a hollow vessel. The microwave-transparent container 105b, is made from a material(s) so as to allow the permeation and not to allow reflection of the microwave energy of the frequency 2.45 GHz or 915 MHz, through its surfaces. It needs also to be mechanically rigid and robust so that it can be cleaned and used repeatedly for carrying out film deposition. It needs also to be chemically inert so that it is unaffected by the liquid (solution) that it holds and by the chemical reactions that occur when the liquid is irradiated by microwaves.

The microwave-transparent container 105b is equipped to store a liquid 107 comprising chemical precursors. The exemplary chemical precursors that are used in the present invention are metal β-diketonates and their adducts, metal alkoxides and metal acetates. It is to be understood here that other suitable metal-based precursors can also be used. The chemical precursors are chosen so that they are soluble in dielectric solvents, such as alcohols, water, etc. It would be advantageous, but not essential, if the chemical precursors are such that they contain a direct metal-oxygen bond in their molecular structure, as in metal β-diketonates and their adducts. Such direct metal-oxygen bonds facilitate the formation of oxides and their thin films.

The liquid 107 is configured to get irradiated with the microwave energy that is propagated through the microwave-transparent window 109, so that the chemical precursors undergo microwave-irradiated reaction

A removable lid 105a, with its peripheral ends, is connected to the upper portion of the microwave-transparent container 105b as shown in FIG. 1(a). The lid is made of a microwave-transparent material, such as fused quartz or PTFE or borosilicate glass or any other material that allow very low absorption or reflection of microwave irradiation of the frequency 2.45 GHz or 915 MHz.

A stem 106 is connected to the removable lid 105a, with a vertical orientation to the base axis 111, to assist in the placement on and the removal from the microwave-transparent container 105b. The stem is made of a mechanically rigid, strong, and microwave-transparent material, such as fused quartz. The removable lid 105a is used to fill the microwave-transparent container 105b with the liquid 107. A suitable drain means, such as a drain pump, can be suitably adapted for use, to drain the liquid 107 from the microwave-transparent container 105b.

A substrate 104 is rigidly connected to the lower portion of the removable lid 105a, in a face-down configuration. “Face-down” configuration means that the surface of the substrate to be coated with a film is facing down and “exposed” to the liquid and comes into contact with it, whereas the other surface is attached to the substrate holder so that it does not come into contact with the liquid. As such, under microwave irradiation, only the “face-down” portion of the substrate gets coated with a film due to chemical reactions occurring in the liquid.

In this exemplary embodiment, the substrate 104 is adhered to the holder through vacuum suction. Other suitable means for firmly attaching the substrate 104 to the substrate holder portion can be suitably used. For example, to hold the substrate to the lower portion of the lid 105a, a vacuum channel from the known art can be integrated in the lid 105a through the stem 106 and can be connected to a suction pump outside the apparatus. In absence of a vacuum channel, a mechanical support can be configured to hold the substrate 104 tightly in a fashion not to allow the liquid 107 access the back side of the substrate 104b.

The substrate preferably has flat surfaces and may be of any shape and size, as long as it is smaller than the substrate holder. For example, it may be circular, rectangular, or square.

In this arrangement, the substrate 104 is positioned directly above the microwave-transparent window 109, as shown in FIG. 1(a) and exposed to the microwave waves that are permeating through the microwave-transparent window 109. The preferred substrate for the present invention is a semiconductor or an insulator. It is also within the purview of the invention to use a semiconductor or an insulator with a thin-film metal pattern on it. The exemplary substrates are selected from wafers of Group IV semiconductors, such as Si and Ge, III-V semiconductors such as GaAs, indium phosphide (InP) and GaN, II-VI semiconductors such as CdTe and ZnO, silicon carbide (SiC), polymers, aluminium oxide, glass, Ga₂O₃, MgO, diamond, fused quartz, or wafers of the stated materials with a thin metal coating.

The size of the substrate (on which a film can be deposited) can range in size from a few millimetres (mm) across to approximately the size of the uniform microwave field in the substrate cartridge chamber 110 which, in turn, is determined by the size of the microwave-transparent window 109 and the configuration of the array of ports 103. There is no intrinsic limit to the count of MGUs and thus the array of ports 109. However, in the context of a thin film deposition for a semiconductor device fabrication, the substrate size (in area) can preferably be 600 cm². Therefore, a substrate of any smaller size would also be suitable for use in conjunction with the apparatus of the present invention. Accordingly, the preferred size of the substrate (104) for the deposition of film using the apparatus of the present invention is in the range of 1-2000 cm²

The assembly of the microwave-transparent container 105b, the removable lid 105a and the stem 106, constitutes a cartridge 105. The cartridge assembly 105, including the stem 106, are made of a microwave-transparent, rigid, workable material, such as fused quartz. The various components of the cartridge assembly 105 have dimensions, such as thickness, that are chosen to make them mechanically robust, chemically inert, and amenable to cleaning with suitable solvents, including acids.

The substrate cartridge 105 is arranged inside the substrate cartridge chamber 110 and on the the microwave-transparent container 105b.

The removable lid 105a is provided with vents 108 as shown in FIG. 1(b). As shown in FIG. 1(b), the vents are holes of suitable size formed along a circle in the rim of the substrate holder. The vents 108 serve remove the vapours of the liquid, if any, generated when it is irradiated by microwaves as part of the process for film deposition. It is also within the purview of the invention to use the removable lid 105a without any vents. The vents 108 can serve the purpose of releasing the vapor generated during the microwave irradiation. In another aspect, the vents 108 can be repurposed in a way to feed fresh liquid 107 into the microwave transparent container 105b during and/or an intermediated stage of the deposition process. In another aspect, the vents 108 can be repurposed to drain the reacted liquid after the completion of the deposition process. In another aspect, the vents 108 can be used to feed liquid cleansing solutions to wash and dry the microwave transparent container after the deposition process.

An assembled view of the cartridge 105 is as shown in FIG. 1(c). In this assembled view, a film 119 of the reacted product of selected chemical precursors that is deposited on the face-down portion of the substrate 104, is illustrated. In FIG. 1(c), “t” indicates the thickness of the substrate; “h” is the height of the liquid column underneath the substrate surface/film surface. It is to be noted that the thickness of the film 119 is shown in an exaggerated manner for clarity; it is of the order of micrometres, whereas “h” is of the order of millimetres.

An exploded view of the cartridge 105 is shown in FIG. 1(d) to illustrate the surfaces 104(a) and 104(b) of the substrate 104. The surface 104(a) is a face-down surface, which is used for the deposition of the film 119, whereas the surface 104(b) is used to attach it to the lower portion of the removable lid 105(a), which serves as the substrate holder. Typically, the surface 104(a) is prepared through protocols that include cleaning it with solvents, so that the film that is deposited through microwave irradiation-assisted chemical reactions, adheres firmly to the substrate 104.

The removable lid 105a is connected to the microwave-transparent container 105(b) through a rivet 105b1 by engaging it with a corresponding groove 105a1, as shown in FIG. 1(d). The allows the lid to rest firmly on the container 105(b), even when the cartridge assembly is rotated about the vertical axis of the stem 106.

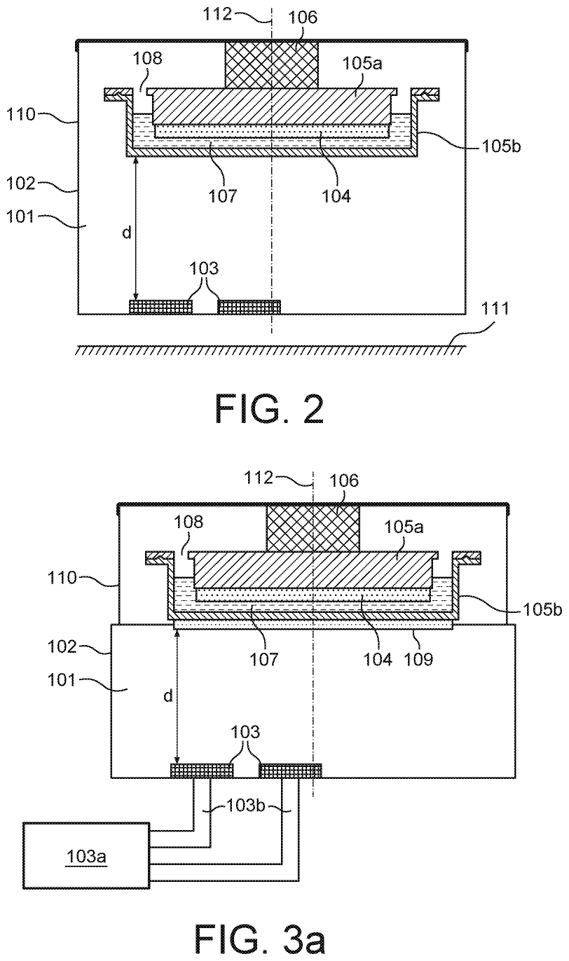

In another exemplary embodiment of the present invention, the cartridge 105 is arranged in the applicator 101, as shown in FIG. 2. In this configuration, the reactant liquid and the substrate would be closer to the MGU. As such, for a given MGU power, the microwave field would be stronger at the liquid and the substrate than would be the case if the cartridge were to be in the substrate cartridge chamber 110. This configuration would be suitable where the chemical reactions that result in the deposition of a film on the substrate requires a stronger microwave field (as would be the case if inorganic salts like halides are used as chemical precursors). This configuration would also be suitable if “clean conditions” are required for the deposition of the film desired.

An arrangement of MGU assemblies 103a is connected to the array of ports 103, through wave guides 103b as shown in FIG. 3(a). The MGU(s) are connected to the applicator 101 in such a configuration that the microwave field that is generated is as uniform as possible in the (X-Y) plane perpendicular to the vertical (Z axis) 112 of the apparatus 100. This is achieved by modelling the microwave field as a function of the number of MGUs, their power and their (XYZ) coordinates. The rendering of uniform microwave field in the X-Y plane inside the applicator 101, is carried forward into the substrate cartridge chamber 110. A high degree of permeation of the microwave field from the applicator 101 into the substrate cartridge chamber 110, through the microwave-transparent window 109, enables the presence of a strong microwave field inside the substrate cartridge chamber 110.

FIG. 3(b) and FIG. 3(c) show different configurations of the ports through which microwave radiation enters the applicator and then the SCC (through the microwave-transparent window 109). As described above, the configurations are determined through computations based on electromagnetic theory so that the desired strength and uniformity of the microwave field is obtained in the liquid column 107 and the substrate surface 104a.

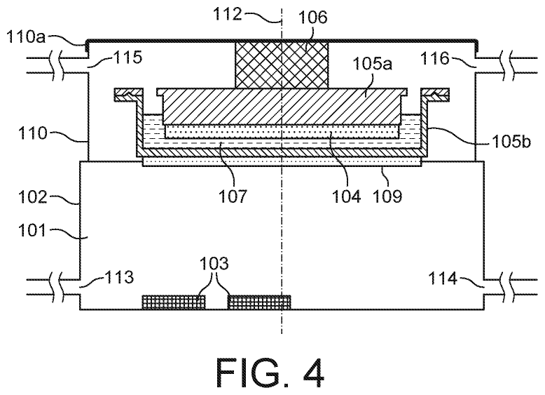

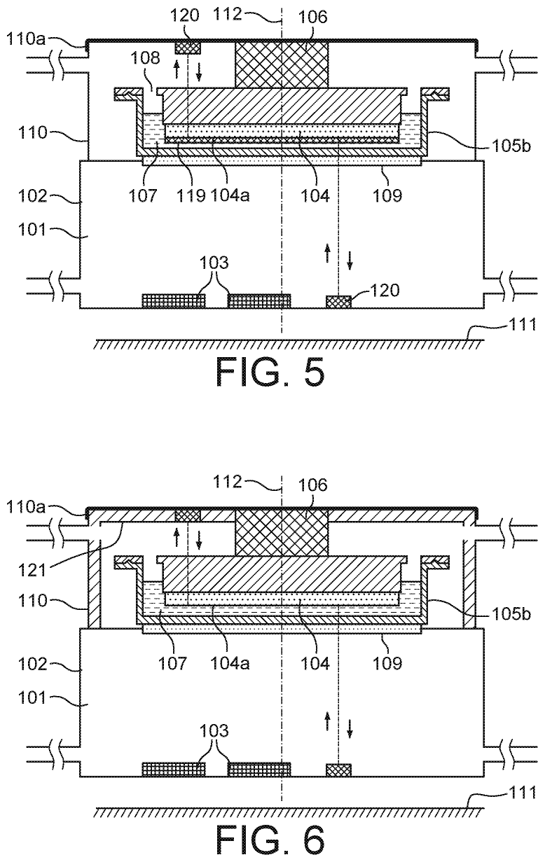

In yet another aspect of the present invention, as shown in FIG. 4, a gas injection inlet 115 is provided to the substrate cartridge chamber 110, along with a conduit 116 for creating and controlling a sub-atmospheric pressure in 110. The gas injection inlet 115 is used to fill the substrate cartridge chamber 110 with suitable gases required to assist with the chemical reactions that result in depositing the desired film on the substrate 104. Suitable gases may also be used to clean the walls of 110 and the surfaces of the cartridge 105, as and when necessary. The conduit 116 is used for evacuation of the the substrate cartridge chamber 110 to attain the desired pressure condition. In a similar way, gas injection inlet 113 is provided to the applicator 101, along with a conduit 114 for controlling vacuum. In this arrangement, since gases absorb microwaves, an ambient control is established, including the evacuation of the applicator 101 to the desired low pressure, allows for the strength (intensity) of the microwave field to be controlled suitably. The combination of the gas inlet and the gas injection system, allows for the desired gas to be injected in the 101. In combination with a vacuum system 115, the pressure of the ambient in the microwave cavity 101 may be controlled as desired. Furthermore, by not operating the vacuum system, the pressure of the ambient in the microwave cavity 101 can be maintained at atmospheric pressure or above atmospheric pressure.

The applicator 101 of the present invention is also provided with a probe 120 to monitor the characteristics of the liquid of the microwave-transparent container 105b and film growth or thickness of the film on the substrate 104, is disposed in the applicator 101 and in the substrate chamber 110, as illustrated in FIG. 6. In this arrangement, the growth of film(s) is measured and monitored during deposition and after its completion. In this arrangement, the probe 220 is a transmitter-receiver assembly that is selected from infrared (IR), ultraviolet (UV), visible light (V) and ultrasonic devices, where a beam of light is made incident on a growing film 119. The beam is reflected both from the surface of the film 104a and from the surface of the substrate 104. Interference between these two beams facilitates for the determination of the thickness of the film 119.

The upper and side portions of the walls 121 of the substrate cartridge chamber 110 may be coated with a microwave-absorbing material, as shown in FIG. 6. The preferable microwave-absorbing materials include silicon carbide (SiC) or strontium hexaferrite (SrFe₁₂O₁₉). Such a coating, if employed, works with the configurations shown in FIG. 3(b) and FIG. 3(c) to achieve the desired microwave field strength and uniformity in the desired location in SCC, 110.

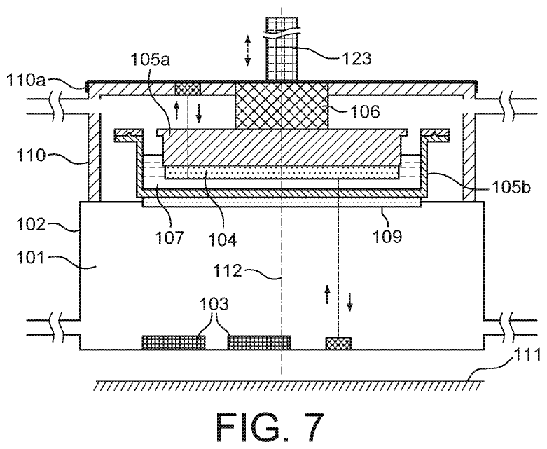

Now, the preferred embodiments relating to the movement of the substrate cartridge 105, of the apparatus 100 of the present invention, to achieve optimum conditions for film deposition are now described. As shown in FIG. 7, a dual-motion actuator 123 is connected to the stem 106, to exercise a control over the position and movement of the substrate cartridge 105. The substrate cartridge 105 is actuated to move along the z-axis 112 i.e., vertical movement and also to rotate about the z-axis 112. The dual-motion actuator 123 includes an arrangement where a rotary actuator and a linear actuator are combined to provide an independent linear and rotary motion. The dual-motion actuator 123 can be a device that is a mechanical, an electro-mechanical, a hydraulic or a pneumatic device.

The connectivity of the dual-motion actuator 123 allows for a controlled pulsed vertical movement of the substrate cartridge 105. Such a pulsed movement along the z-axis can expose the substrate 104 to the liquid 107 in controlled manner, so as to achieve the desired film deposition.

The connectivity of the dual-motion actuator 123, to the substrate cartridge 105, through the stem 106, enables movements of the substrate cartridge 105, in the form of controlled, pulsed translational and rotational movements. Such movements about the Z-axis allow the rotation of the substrate cartridge 105, to ensure a greater uniformity in the thickness and composition of the films, especially while depositing on a substrate, which is larger than a one inch (1″) diameter wafer. The combination of the translational and rotational movements of the substrate cartridge 105, during the microwave irradiation, provides with a dynamic tool, i.e., real time stepper-motor-like control during the deposition process based on the feedback on the thickness and composition obtained from the probe, to homogenize the film deposition condition suitable for obtaining a uniform film.

The speed of rotation of the substrate 104 is preferably in the range of 1 to 100 rpm and is effected by a suitable driving arrangement, such as a gear assembly, that is connected to the stem 106.

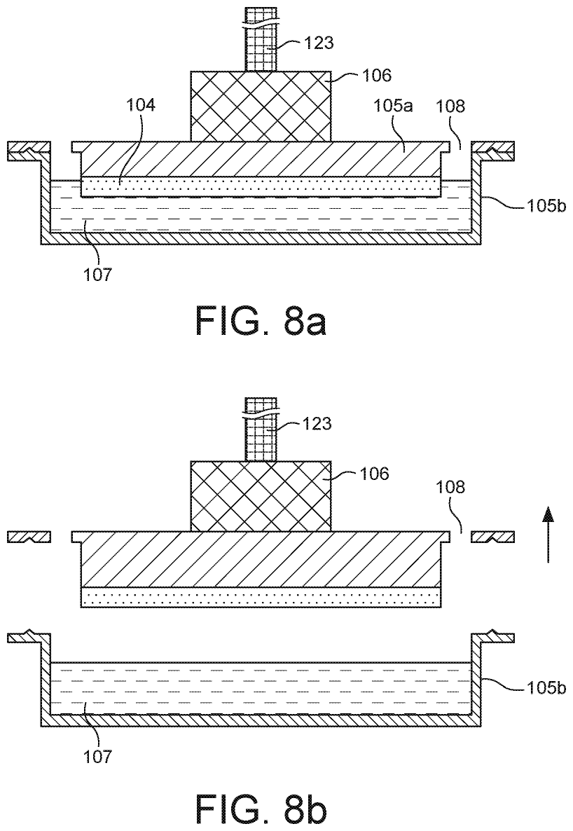

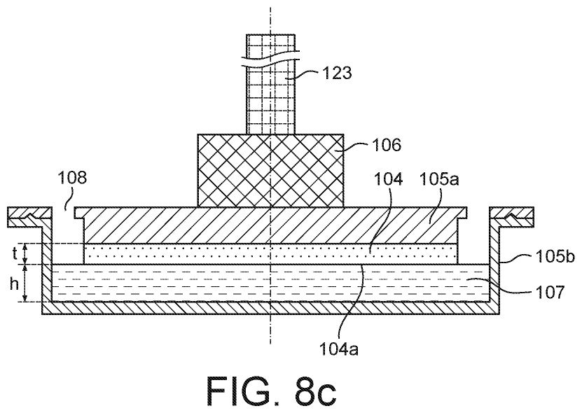

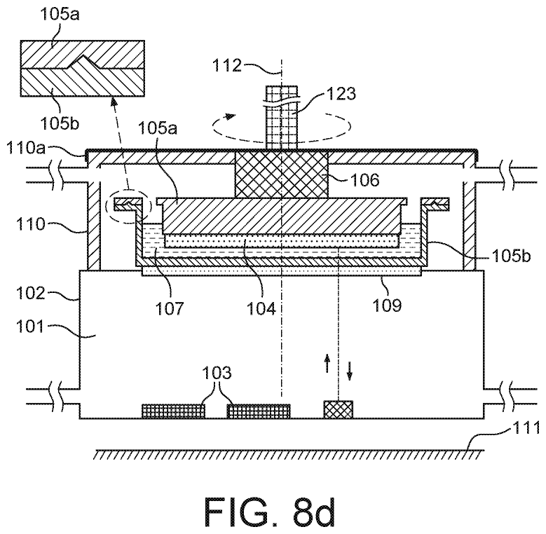

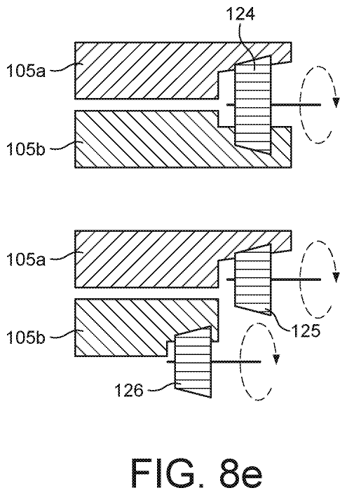

As shown in FIG. 8(a), the substrate cartridge 105 with the substrate 104 is immersed in the liquid 107 of the microwave-transparent container 105b. This disposition, which places the face-down surface of the substrate in contact with the liquid 107, is a preparatory step in the deposition of the desired film on the substrate surface 104a.

The substrate cartridge 105, as shown in FIG. 8a, is in contact with the liquid 107 through immersion. The quantity of the liquid 107 taken in the substrate cartridge 105 and the extent to which the substrate 104 is immersed in the liquid 107 can be selected suitably. In other words, the height “h” of the liquid 107, which lies beneath the lower surface of the substrate 104 is selected suitably.

In order to lift the substrate cartridge 105 from the microwave-transparent container 105b, a pulsed-vertical movement of the dual-motion actuator 123 is performed, from outside of the substrate cartridge chamber 110, through the cartridge stem 106, as shown in FIG. 8(b). It can be seen from FIG. 8(b) that the removable lid (105a) along with the substrate cartridge 105 is detached from the microwave-transparent container 105b.

In yet another aspect of the present invention, the apparatus 100 as shown in FIG. 8(c), illustrates an arrangement for a controlled vertical displacement or movement of the substrate cartridge 105, to bring the front surface alone of the substrate 104a in contact with the liquid 107, so as to ensure that the substrate 104 is not immersed in the liquid 107. Such a liquid-skimming disposition of the substrate 104, not only prevents deposition of the film on the sides (rim) of the substrate 104, but also prevents deposition on the back surface 104b of the substrate i.e., the surface that is closer to the stem 106. It is to be noted that, in FIG. 8(c), “t” indicates the thickness of the substrate; “h” is the height of the liquid column underneath the substrate surface/film surface.

The constructional arrangement of the substrate cartridge 105, includes capability to achieve a rotation of the substrate cartridge 105 around the Z-axis 112. The capability for rotation around the z-axis, during microwave-assisted process, permits a greater uniformity in the characteristics and thickness of the film deposited across the substrate 104. Rotation of the substrate relative to the liquid column 107 compensates for any non-uniformity of the microwave field across the liquid column 107 and across the face-down surface 104b of the substrate. Thus, any non-uniformity in the characteristics and thickness of the film deposited across the substrate, which might arise from the non-uniformity of chemical reactions across 107, is minimised.

FIG. 8(e) illustrates the exemplary embodiments for rotating the substrate cartridge 105. Through the constructional elements as shown in FIG. 8(e) the substrate cartridge 105 can be rotated about the z-axis. However, by incorporating an alternative means shown in FIG. 8(e), the top-half 105a and the bottom half 105b can also be rotated separately.

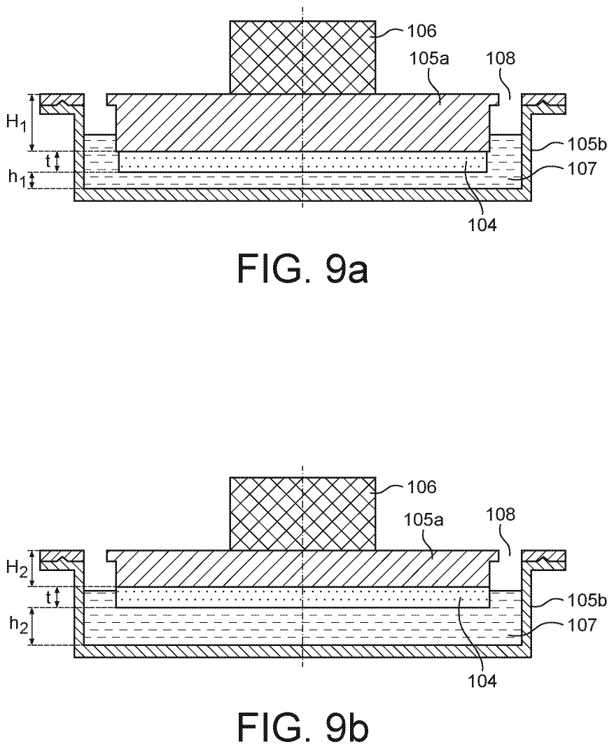

In another aspect of the present invention, as shown in FIG. 9a and FIG. 9b, the thickness “t” of the film 119 on the substrate 104, is pre-determined, by considering a thickness “H1” and “H2” of the removable lid 105a and the distance “h1” and “h2” between the bottom surface of the the microwave-transparent container 105b and the front surface 104a of the substrate 104. This pre-determination of film thickness arises from the precisely repeatable distances (H1, h1) and (H2, h2), for a given “t”, the thickness of the substrate. For a given (H1, h1), the microwave field intensity in 107 and at 104b are precisely defined. This leads to chemical reactions that lead to the deposition of a film of a certain thickness. By repeating the process, a film of the same thickness can be deposited each time for a given (H1, h1). Similarly for a given (H2, h2). Thus, a film of the same desired characteristics and thickness can be obtained during each “process run”.

Accordingly, in the apparatus 100 of the present invention, the height of the liquid 107 in the microwave-transparent container (105b), can be varied without varying the vertical movement of the substrate cartridge 105. As illustrated in FIG. 9a, the thickness “H1” of the removable lid 105a can be altered suitably. It is to be noted the thickness of the liquid 107 through which microwaves have to pass determines the strength (intensity) of the microwaves at the substrate surface (the surface that is facing down). Hence, the vertical height of liquid column “h1” in the substrate cartridge 105 is significant parameter in the MAS process. This height can also be controlled through the vertical movement of substrate cartridge 105.

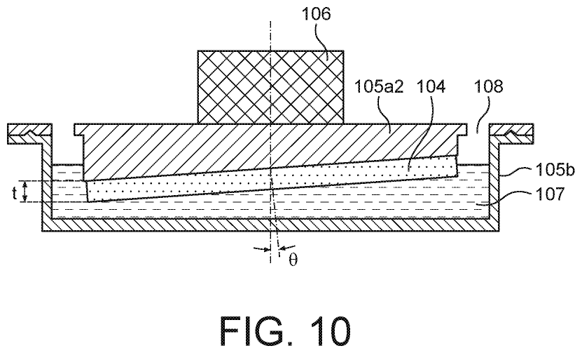

The constructional features of the substrate cartridge 105 to obtain a film 119 with a gradient are now described by referring to FIG. 10. In this arrangement the substrate 104 is tilted with respect to the horizontal to base plane 111, at a desired angle (e). This arrangement allows for the vertical height of the liquid 107 through which microwaves travel, to be different at different points on the substrate 104, resulting a gradient to be present in the film that is deposited on the substrate 104. This gradient may be in the thickness “t” of the film or the composition, or both. The gradient in film thickness across the substrate arises from the gradient in microwave field strength in the liquid 107 which, in turn depends on the height of the liquid column at a given point on the substrate surface 104a. A gradient in film composition arises because of the gradient in the microwave field across the surface, as such a gradient affects the chemical reactions that lead to film deposition and film composition. Alternatively, if the tilted substrate 104 is rotated about the z-axis, a greater homogeneity in the film can be achieved, when the tilt is small (a few degrees) to the base axis 111. The small tilt and the rotation of the substrate cartridge 105, can compensate for the non-uniformity in film characteristics that otherwise might occur. The said non-uniformity occurs due to minute non-uniformities in microwave field strength across the substrate surface. Hence, a small tilt and rotation of the substrate cartridge 105 can compensate for the non-uniformity in film characteristics that otherwise might occur.

In addition, the cartridge configuration of the present invention leads to a desirable gradient in nucleation density in the liquid 107 when irradiated by microwaves. This is because the layer of 107 closest to the window 109 experiences a stronger microwave field than the layer of 107 in contact with 104a. Thus, a gradient in temperature and nucleation density occur in 107, with both the temperature and nucleation density being lower at 104b. This gradient in nucleation density favours the diffusion of nuclei towards 104b, which is precisely what favours the deposition of the desired film on 104b.

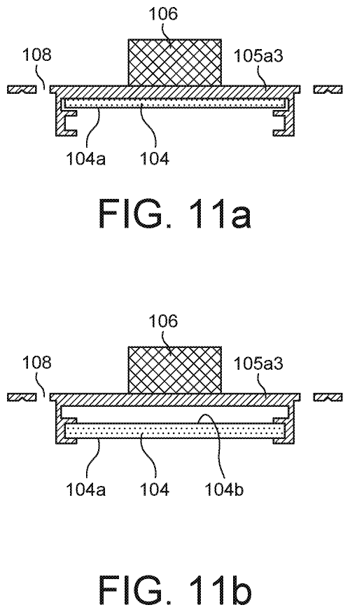

In yet another aspect of the present invention, as shown in FIG. 11, the removable lid 105a is modified to facilitate a deposition of film on both sides of the substrate 104. The modified removable lid 105a3 includes inner protrusions 105a4. The protrusions 105a4 provide anchoring spaces for fixing the substrate 104. In other words, two different of levels of anchoring of the substrate 104 are provided on the inner portion of the removable lid 105a. Accordingly, when the substrate 104 with surfaces 104a and 104b are immersed in the liquid 107, both the surfaces 104a and 104b of the substrate 104 are surrounded by the liquid 107. which irradiation with microwaves, the microwave-assisted (MAS) process takes place, resulting in deposition of the film on both surfaces 104a and 104b of the substrate 104. However, the thickness of the film may be different on both the surfaces 104a and 104b, since the microwave field strength is likely to be different on the two sides of the substrate. If the same film thickness is desired on both the surfaces 104a and 104b of the substrate, a deposition run is conducted under defined conditions with the substrate in place as shown in FIG. 11(b). After this deposition, the substrate is removed, turned upside down, and placed in the configuration of FIG. 11(b). A deposition run is now conducted under the same conditions as defined above. The two depositions, together, give a film of the same thickness on both sides of the given substrate.

It is also within purview of the present invention, to construct more anchoring spaces, for holding more than one substrate, for a simultaneous film deposition. It is to be noted that, if the substrate is thin and transparent to microwaves, both sides of it may be deposited with film simultaneously and equally.

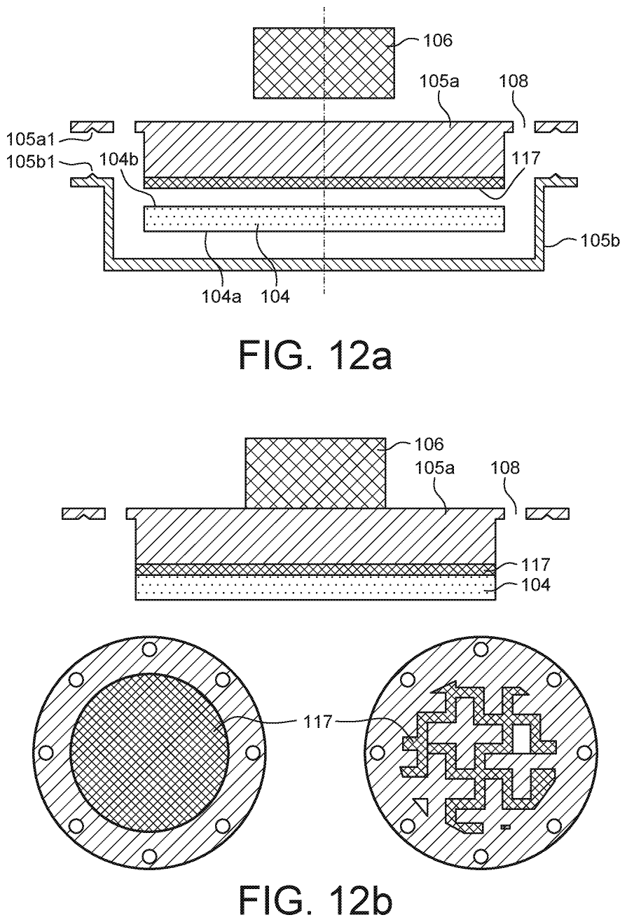

As shown in FIG. 12(a), the substrate cartridge 105 is also constructed, to modify a microwave field that is propagated in the substrate cartridge chamber 110, so that the deposition process (processing of materials) can be tuned in a desired manner, both dynamically and statically. Such a modification and tailoring of the microwave field is achieved by having an electrically conducting layer 117, which is fixed to bottom portion of the removable lid 105a and the substrate 104. For example, the conducting layer 117 may be metal sheet of suitable size, shape and thickness that is sandwiched between bottom of 105b and the surface 104b of the substrate. The metal layer 117 alters the microwave field in a way that depends on the geometrical and material details of the electrically conducting layer (which is preferably made of a metal or a metal alloy). FIG. 12(b) shows a bottom view of metal layer 117 with desired patterns. In the arrangement as shown in FIG. 12(a) and FIG. 12(b), the pattern can be designed in such a way as to achieve film deposition in selected areas of the substrate 104, through the modification of the microwave field caused by the pattern of the conducting (metal) layer, i.e., film deposition in chosen parts of the substrate, with no film deposition in other parts. The pattern can also be designed to achieve differential film deposition, i.e., deposition of films of different thickness at different points on the substrate. In addition, the electrically conducting layer 117 can protect the substrate 104 (a microwave-absorbing substrate to be specific) from the exposure of microwaves at the back side.

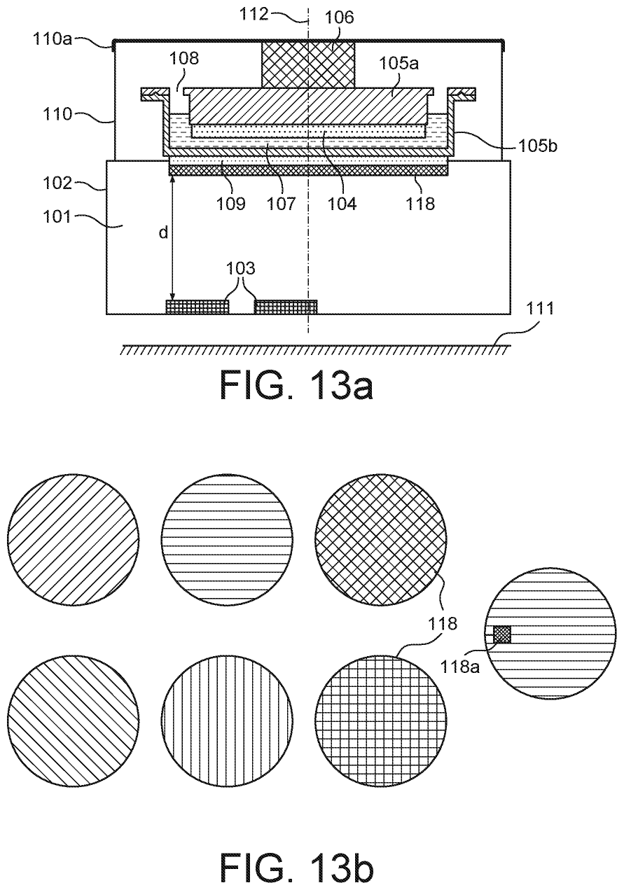

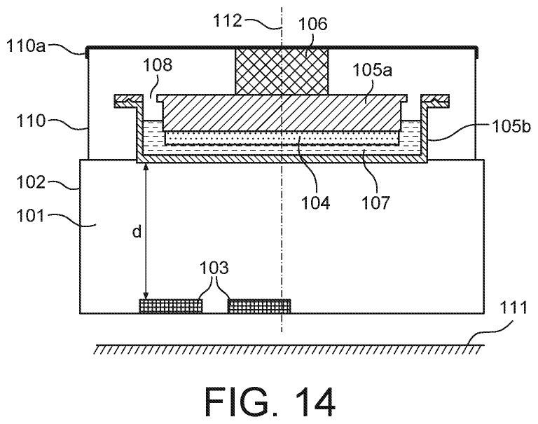

FIG. 13(a) and FIG. 13(b) depict another exemplary embodiment of the electrically conducting pattern that is used to achieve modification of the microwave field in the cartridge chamber 110 (film deposition zone or material processing zone). In this embodiment, a metallic layer 118, with a pattern, is provided for the microwave-transparent window 109. FIG. 13(b) depicts various metal or conducting layer patterns that can be used to modify the microwave field incident on the substrate 104, which enables interaction of substrate 104 and the liquid 107 with a selectively polarized microwave field during the deposition, even in a dynamic manner. That is, the polarization of the microwave field can be altered by using metal patterns as schematically shown in FIG. 13(b). The polarization of the field at the substrate can also be changed dynamically by rotating the metal pattern during microwave irradiation from the array of ports 103. Such a control of polarization of the microwave field at the substrate 104 provides a way to control the chemical reactions that lead to film deposition and, thus, to control the characteristics of the film deposited either dynamically or statically. An embodiment of the metallic layer 118 repurposed to measure the intensity of the incident microwave field termed as antenna element 118a. This antenna element receive the microwave field intensity and then process it with necessary signal processing electronics to return the field intensity measurement in V/m term.

Accordingly, the deposition of thin films and/or coatings on a selected substrate 104, is performed by using the apparatus 100 of the present invention, wherein the microwaves that are generated by the MGUs 103a enter the applicator 101 through the array of ports 103. The microwaves then permeate through the microwave-transparent window 109 and enter the substrate cartridge chamber 110, in which the substrate cartridge 105 is placed. The microwaves entering the substrate cartridge chamber 110 irradiate the liquid 107 and the substrate 104, which is arranged in a “face-down” configuration. The microwave irradiation of the liquid 107, with desired chemical precursors, causes chemical reactions to take place, creating “nuclei” of the desired material of which a film deposition or coating is performed on the substrate 104. As microwaves enter substrate cartridge chamber 110 from below i.e., from the applicator 101, to irradiate the liquid 107, the temperature of the layer of liquid 107 that comes in contact with the substrate 104 is lower than that of the layer of liquid 107 that is at the bottom portion of the substrate cartridge 105. This implementation facilitates a natural convection, leading to nuclei that are generated in the chemical reaction, to drift to the substrate surface, leading to film deposition.

In addition, in the apparatus 100 of the present invention, the “thickness” of the column of the liquid 107 that is situated underneath the substrate 104 can be controlled suitably. As microwaves are absorbed by the liquid column, the strength of the microwave field at the surface of the substrate 104 can therefore be controlled suitably.

Accordingly, the microwave-assisted apparatus (100) for deposition of a film on the substrate (104), comprises, the applicator (101) with the microwave-transparent window (109) and the array of ports (103) disposed at the intervening distance ‘d’ from the microwave-transparent window (109), to receive the microwave energy from the microwave generating units (103a). The substrate cartridge chamber (110) with the removable cover (110a) is mounted on the applicator (101). The cartridge (105) including the microwave-transparent container (105b) with the removable lid (105a) and the stem (106), is removably disposed in the substrate cartridge chamber (110) and the stem (106) being connected to the removable cover (110a). The microwave-transparent container (105b) configured to store the liquid (107) with chemical precursors and the liquid (107) is disposed to get irradiated with a uniform microwave field intensity that is propagated through the entirety of the microwave-transparent window (109), to cause the chemical precursors to undergo microwave-assisted reaction. The substrate (104) is detachably connected to the removable lid (105a) and its facedown portion configured to be in contact with the irradiated liquid (107), for deposition of the reacted product of the chemical precursors, as the film (119), on the surface of the substrate (104).

In an aspect of the present invention, the material for the microwave-transparent window (109) is a fused quartz, polytetrafluoroethylene (PTFE) or a single crystal aluminium oxide (Al₂O₃).

In another aspect of the present invention, the vents (108) are disposed on the removable lid (105a).

In yet another aspect of the present invention, the cartridge (105) is disposed in the applicator (101).

It is also an aspect of the present invention, wherein the ports (103) as the array are horizontal and offset to a base plane (111) and are disposed symmetrical or asymmetrical to a central axis (112) of the microwave-transparent window (109).

In yet another aspect of the present invention, the gas injection and vacuum channels (113, 114, 115, 116) are connected to the applicator (101) and the substrate chamber (110), respectively.

In yet another aspect of the present invention, the probe (120) to monitor liquid characteristics in the microwave-transparent container (109) and the growth of the film (119) on the substrate (104), is disposed in the applicator (101) and in the substrate chamber (110) and the probe (120) is a transmitter-receiver assembly, selected from infrared (IR), ultraviolet (UV), visible light (V) and ultrasonic devices.

In still another aspect of the present invention, the upper and side portions of the walls (121) of the substrate cartridge chamber (110) are coated with a microwave-absorbing material, preferably with silicon carbide (SiC) or strontium hexaferrite (SrFe₁₂O₁₉).

It is also an aspect of the present invention, wherein the dual-motion actuator (123) is connected to the stem (106) of the cartridge (105) and the cartridge (105) is configured to rotate about a vertical axis (112) and move vertically with respect to the base plane (111).

In yet another aspect of the present invention, the removable lid (105a) and the microwave-transparent container (105b) are disposed to rotate reciprocally and differentially.

It is also an aspect of the present invention, wherein the substrate (104) is disposed to be immersed in the liquid (107).

In still another aspect of the present invention, the removable lid (105a) is of variable thickness.

It is also an aspect of the present invention, wherein the bottom surface of the removable lid (105a) is with a gradient profile (105a2), and the gradient profile is at an inclination angle, in the range of 1-30 degree from the base plane (111).

It is also an aspect of the present invention, wherein a holder (105a3) is connected to the removable lid (105a) and is made of a microwave-transparent material, preferably a fused quartz or polytetrafluoroethylene (PTFE).

In still another aspect of the present invention, the electrically conducting layer (117) is disposed between the removable lid (105a) and the substrate (104) and the electrically conducting layer (117) is continuous or patterned.

In yet another aspect of the present invention, the metallic layer (118) is connected to the microwave-transparent window (109) facing the inner portion of the applicator (101) and is configured as polarizer and antenna (118a).

In still another aspect of the present invention, the microwave-transparent container (105b) is disposed in lieu of the microwave-transparent window (109).

In yet another aspect of the present invention, the material for the substrate (104) is selected from metal, a metallic alloy, a semiconductor or an insulator.

In still another aspect of the present invention, the size of the substrate (104) is in the range of 1-2000 cm².

In yet another aspect of the present invention, the average surface roughness of the film is in the range 1-50 nm and the thickness in the range of 10 nm to 100 μm.

\In still another aspect of the present invention, the substrate (104) is configured to rotate at a speed in the range of 1 to 100 rpm.

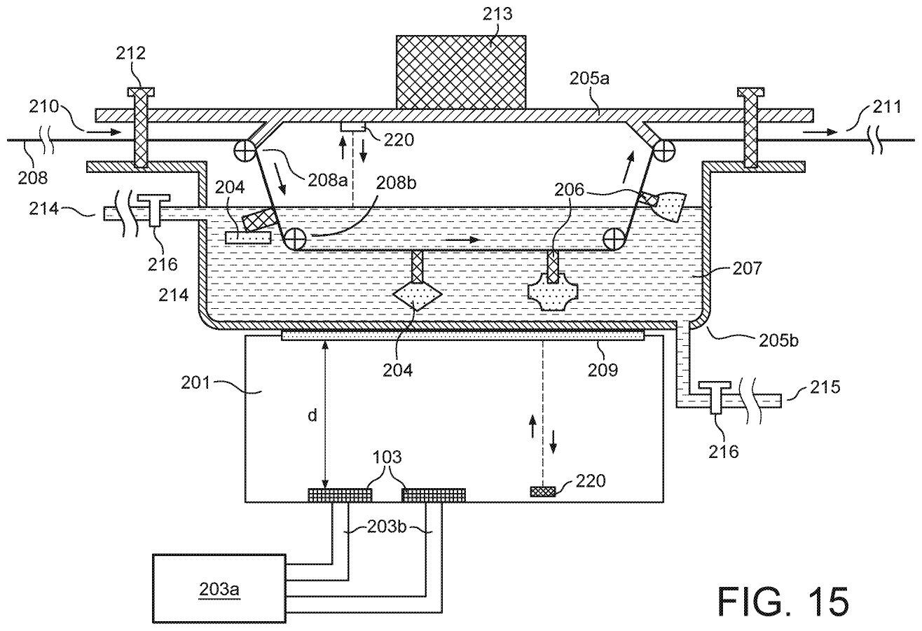

The preferred embodiments of an apparatus 200 for depositing films on multiple substrates 204 are now described by referring to FIG. 15. The apparatus 200 comprises an applicator 201. The applicator 201, acts as a first chamber and is made of suitable material that can exhibit characteristics such as microwave reflection, electrical conductivity and non-magnetism. An array of ports 203 is formed on the base portion of the applicator 201 and are connected to MGU assembly 203a with wave guides 203b, to receive microwave energy into the applicator 201. A microwave-transparent window 209 is arranged on an upper portion of the applicator 101. Peripheral edges of the microwave-transparent window 209 are suitably connected or fused to peripheral edges of the upper portion of the applicator 201, such that the the microwave-transparent window 109 is connected to the upper portion of the applicator 201, through an appropriate seal, of the kind that is provided by a suitable gasket. The microwave-transparent window 209 is configured to be transparent to infrared (IR) waves, ultraviolet (UV), and a visible light, so that thickness of the film or coatings on the substrate can be monitored during the course of its formation. The applicator 201 along with the microwave-transparent window 209 and the array of ports 203, form a single sealed unit, to receive and propagate the microwave energy. The applicator 201 is also configured to maintain desired sub-atmospheric pressure conditions as hereinafter described.

A probe 220 to monitor liquid characteristics and film growth, is disposed in the applicator 201 and in the substrate chamber 210) and the probe 220 is a transmitter-receiver assembly that is selected from infrared (IR), ultraviolet (UV), visible light (V) and ultrasonic devices.

A microwave-transparent container 205b with side flanges, is placed on top of the microwave-transparent window 209. In this exemplary embodiment, the microwave-transparent container 205b is a large vessel, to accommodate multiple substrates for simultaneous deposition of films. A liquid inlet 214 and outlet 215 with valves 216 are connected to an upper portion and a lower portion of the microwave-transparent container 205b, respectively. The valves 216 enables dynamic replenishment of the liquid during the microwave exposures if needed.

A removable lid 205a is mounted on the microwave-transparent container 205b. Plungers 212 are permitted to pass through the removable lid 205a and into the side flanges of the microwave-transparent container 205b, so that the microwave-transparent container 205b can be sealed from the external environment. The plungers 212 are removed whenever the removable lid 205a is to be detached from the microwave-transparent container 205b. A stem 213 is connected to the removable lid 205a, so as to assist in the removal and placement of the removable lid 205a. The plungers 212 also prevents leakage of microwave radiation from the applicator 201 and the microwave transparent container 205b if any.

Substrate channels 210, 211 are formed between the inner portion of the removable lid 205 and an upper portion (flanges) of the microwave-transparent container 205b. The substrate channels 210, 211 are passages, the sizes of which can be suitably adjusted through the adjustment of the plungers 212.

Hinges are connected to the lower portion of removable lid 205 to which a first set of pulleys 208a is connected. A second set of pulleys 208b is arranged inside the microwave-transparent container 205b as shown in FIG. 15.

A looped substrate transporter 208 is movably connected to first and second pulleys 208a. The looped substrate transporter 208 is preferably a cable assembly, which is connected to a suitable (not shown in the drawing), to enable the movement of the looped substrate transporter 208 over the first and second pulleys 208a. The spooler can be driven by a motor assembly.

Movable stems 206 are connected to the looped substrate transporter 208 so as to suspend from the looped substrate transporter 208. The movable stems 206 travel along with the movement of the looped substrate transporter 208, to make an ingress into and an egress out of the microwave-transparent container 205b, through the substrate channels 210, 211, as shown in FIG. 15. A loading and unloading platforms (not shown in figures) can be suitably connected to the looped substrate transporter 208 to facilitate loading and unloading of the substrates 204.

The substrates 204 are detachably connected to the movable stems 206 and their facedown portions are disposed to be in contact with the irradiated liquid 207, for a deposition of the reacted product of the chemical precursors, as a film, on the surface of the substrates 204 that are in contact with or immersed in the liquid 207. The penetration of microwaves into a liquid 207 varies with length “d” and it is possible to place substrates 204 at different depths to obtain coatings of different thickness at different depths simultaneously. The time spent by the substrate 204 inside the liquid 207 during the exposure of the microwave irradiation is determined by the speed of the movement of the looped substrate transporter 208.

Accordingly, the apparatus (200) for the deposition of thin films and coatings on substrates, comprises the applicator (201) with the microwave-transparent window (209) and the array of ports (203) is disposed at an intervening distance ‘d’ from the microwave-transparent window (209), to receive the microwave energy from the microwave generating unit (203a). The microwave-transparent container (205b) with the removable lid (205a) is mounted on the applicator (201). The microwave-transparent container (205b) is configured to store the liquid (207) with chemical precursors and the liquid (207) being configured to get irradiated with a uniform microwave field intensity that is propagated through the entirety of the microwave-transparent window (209), to cause the chemical precursors to undergo microwave-irradiated reaction. The removable lid (205a) is operable by plungers (212) that are connected to the microwave-transparent container (205b). The substrate channels (210, 211) are disposed between the inner portion of the removable lid (205a) and the upper portion of the microwave-transparent container (205b). The first set of pulleys (208a) is connected to the removable lid (205a) and the second set of pulleys (208a) is disposed inside the microwave transparent container (205b). The looped substrate transporter (208) is disposed to be in movable contact with the first and second pulleys (208a). The movable stems (206) arebconnected to the looped substrate transporter (208) and are configured to make ingress into and egress out of the microwave transparent container (205b), through the substrate channels (210, 211). The substrates (204) are detachably connected to the movable stems (206) and their facedown portions are disposed to be in contact with the irradiated liquid (207), for the deposition of the reacted product of the chemical precursors, as a film, on the surface of the substrate (204) that is in contact with the liquid (207). In the apparatus (200), the inlet (214) and the outlet (215) with valves (216) are connected to the microwave transparent container (205b). The probe (220) is disposed is disposed in the applicator (201) and in the microwave-transparent container (205b), to monitor liquid characteristics in the the microwave-transparent container (205b) and the growth of the film (119), and the probe (220) is preferably a transmitter-receiver assembly that is selected from infrared (IR), ultraviolet (UV), visible light (V) and ultrasonic devices. The substrates (204) as used in the apparatus (200) are of same or different geometrical shapes. In other words, the apparatus (200) supports the deposition of films on different types of substrates concurrently. In this preferred embodiment, the size of the substrate (204) is selected to be in the range of 1-2000 cm².

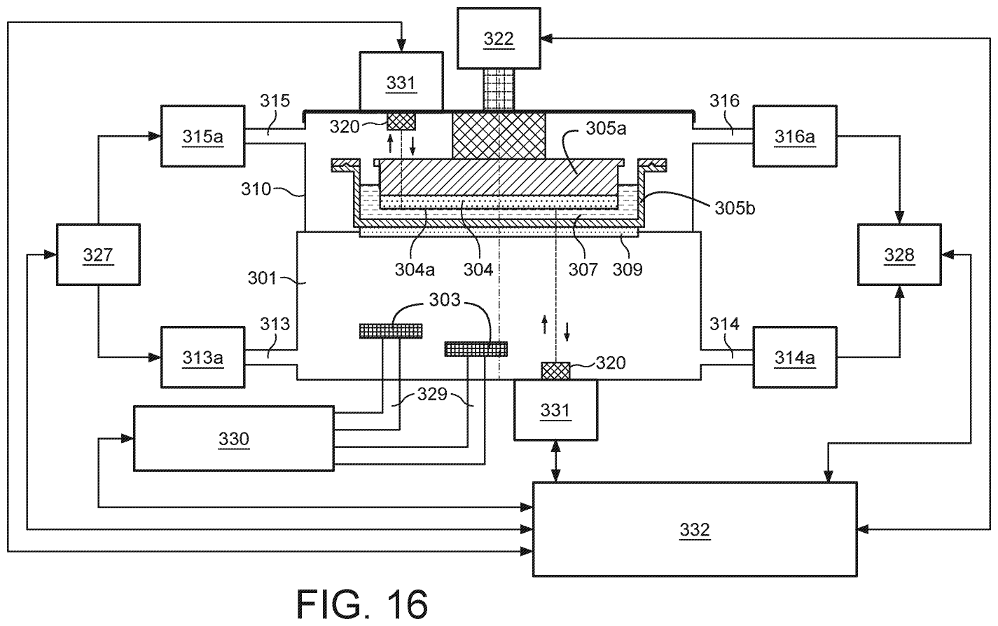

Now the preferred embodiments of the a system 300 for deposition of films on a substrate 304 with are described. A broad schematic architecture is as shown in FIG. 16, using the apparatus 300 of the present invention.

The system 300 comprises, an applicator 301 is provided with a microwave-transparent window 309. An array of ports 303 are disposed to receive a microwave energy from the microwave generation units 330 through the microwave waveguides 329. A substrate cartridge chamber 310 is mounted on the applicator 301. A cartridge 305 including a microwave-transparent container 305b with a removable lid 305a and a stem 306 is removably disposed in the substrate cartridge chamber 310. The microwave-transparent container 305b is a vessel to store a liquid 307 and is disposed to be filled with chemical precursors. The liquid 307 is exposed to microwave radiation that is propagated through the microwave-transparent window 309, to cause the chemical precursors to undergo microwave-irradiated reaction. The substrate 304 is detachably connected to the removable lid 305a and its facedown portion is in contact with the irradiated liquid 307, for a deposition of the reacted product of the chemical precursors, as a film 319, on the surface of the substrate 304 that is in contact with the liquid 307. Microwave generation units 330 are connected to the array of ports 303 through waveguides 329. The microwave generation units 330 comprises preferably magnetrons and other electrical devices including transformers to generate a microwave output power in the range of 0-5 kW with a resolution step size of 1 W. The microwave generation unit is connected to and configured to take instructions from the central control monitoring unit 332. Probes 320 are disposed in the applicator 301 and in the substrate cartridge chamber 310 and are connected to a probe management unit 331. The probe management unit 331 comprises digital signal processing units and digital communication modules to give feedback to and take instruction from the central control monitoring unit 332. The probe management unit 331 also capable of handling driving power requirements of the transmitters and receivers, and instruction storage and microcontroller.

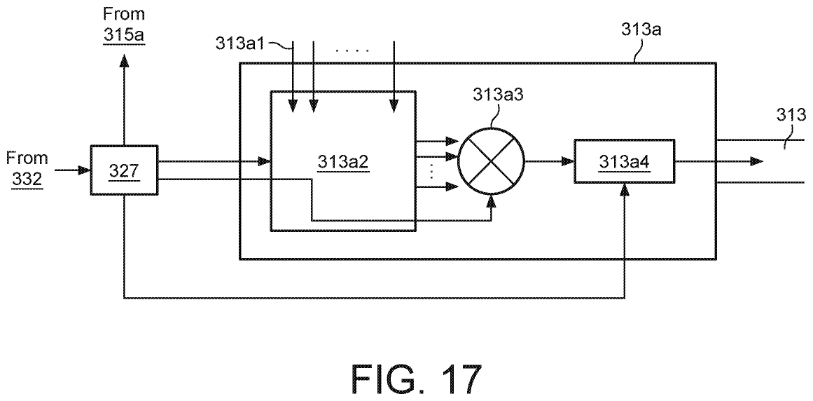

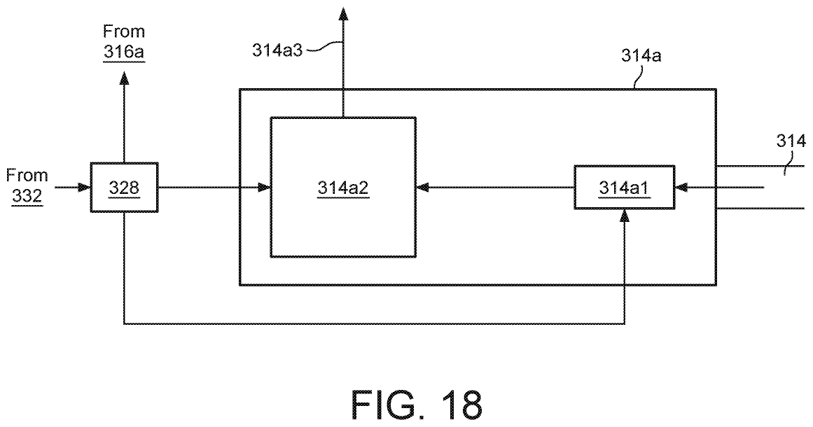

Gas injection and vacuum control units 327, 328 are connected to the substrate cartridge chamber 310 and the applicator 301 through gas and vacuum inlets 315, 313 respectively. The gas injection control unit 327 controls and monitor the activity of gas injection systems 313a and 315a. The internal connections and major parts of the gas injection system 313a (which is identical to 315a) is shown in FIG. 17 that comprises multiple gas inlets from the respective gas cylinders 313a1, associated pool of mass-flow controllers 313a2, a gas mixer 313a3, and a control valve 313a4. Similarly, the vacuum control unit 328 controls and monitor the activity of the gas exhaust system 314a and 316a. A representative diagram of the internal connections and major parts of the gas exhaust system is shown in FIG. 18, showing the control valve 314a1, a vacuum pump 314a2, and an exhaust gas line 314a3.

A stem movement control unit 322 is connected to a stem (306) through a dual-motion actuator 323. The stem movement control unit 322 is internally connected to the central control monitoring unit 332 and is capable of two-way communication with the same to give feedback to and take instruction from the central control monitoring unit 332.

A central control monitoring unit 332 is disposed and is configured to communicated with various other components of the system, including, the gas injection control unit 327, the microwave generation unit 330, the probe management unit 331, the gas exhaust control unit 328 and the stem movement control unit 322. The central control monitoring unit 332, in an illustrative embodiment, includes a processor, a memory and a data storage that together form at least a part of a programmed computer. The programmed computer in operation, performs logical operations for the system 300 of the present invention. The central control monitoring unit 332 includes one or more processors each capable of executing program instructions on data. The memory unit may include a non-volatile memory. The central control monitoring unit 332 is connected to the microwave energy generating units 330 so as to regulate the microwave energy and port positions.

The central control monitoring unit 332 is connected to the an metallic layer 318 and arranged to measure the intensity of the microwave field propagated from the array of ports 303 by using the embodiment antenna element 118a. The antenna element feed the field intensity information real time to the central control monitoring unit 332, which in turn tune the output power of the microwave generation units 330 and the physical arrangement of each ports of the array of ports 303 in a iterative manner to attain the desired field intensity level at the antenna element 118a. The central control monitoring unit 332 is connected to the gas injection and vacuum control units 327, 328 and arranged to control the ambient of the applicator 301 and the substrate cartridge chamber 310. The central control monitoring unit 332 is connected to the stem movement control unit 322 and is enabled to control the movement of the cartridge 305, the cartridge 305 including the microwave-transparent container 305b with the removable lid 305a and the stem 306, the substrate 304 and the liquid 307. The central control monitoring unit 332 is connected to the probe management unit 331 and is arranged to probe the liquid characteristics and the film growth.

Accordingly, the system (300) for deposition of a film on a substrate, comprises, the applicator (301) with the microwave-transparent window (309) and the array of ports (303) that are disposed at an intervening distance ‘d’ from the microwave-transparent window (309), to receive the microwave energy from the microwave generating unit (303a). The substrate cartridge chamber (310) is mounted on the applicator (301). The cartridge (305) including a microwave-transparent container (305b), the removable lid (305a) and the stem (306) is removably disposed in the substrate cartridge chamber (310). The microwave-transparent container (305b) is configured to store the liquid (307) with chemical precursors and the liquid (307) is configured to get irradiated with the uniform microwave field intensity that is propagated through the entirety of the microwave-transparent window (109), to cause the chemical precursors to undergo microwave-irradiated reaction. The substrate (304) is detachably connected to the removable lid (305a) and its facedown portion is configured to be in contact with the irradiated liquid (307), for the deposition of the reacted product of the chemical precursors, as the film (319), on the surface of the substrate (304) that is in contact with the liquid (307). The microwave energy generating units (330) connected to the ports (303) through waveguides (329). The probes (320) are disposed in the applicator (301) and in the substrate cartridge chamber (310) and being connected to a probe management unit (331). The gas injection and vacuum control units (327, 328) are connected to the substrate cartridge chamber (310) and the applicator (301) through gas and vacuum inlets (315, 313) respectively. The stem movement control unit (322) is connected to the stem (306) through the dual-motion actuator (323). The central control monitoring unit (332) is operably connected to the microwave energy generating units (330) and is configured to regulate the microwave energy and port positions. The central control monitoring unit (332) is also connected to the electrically conducting layer (318) and is configured to measure a field intensity of the microwave energy. The central control monitoring unit (332) is also connected to the gas injection and vacuum control units (327, 328) and are configured to control the ambient of the applicator (301) and the substrate cartridge chamber (310). The central control monitoring unit (332) is further connected to the stem movement control unit (322) and is configured to control the movement of the cartridge (305) including the microwave-transparent container (305b) with the removable lid (305a) and the stem (306), substrate (304) and the liquid (307) and the central control monitoring unit (332) is also connected to the probe management unit (331) and is configured to probe the liquid characteristics and the film growth.

In the system of the present invention, the probes (320) are transmitter-receiver assemblies that are selected from infrared (IR), ultraviolet (UV), visible light (V) and ultrasonic devices. microwave energy generating units (330) are preferably solid state MGUs.

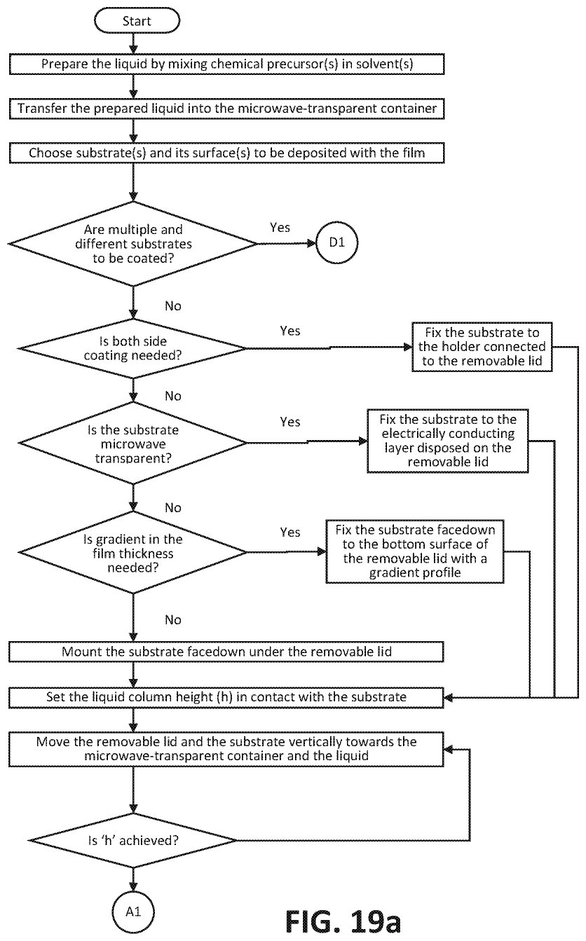

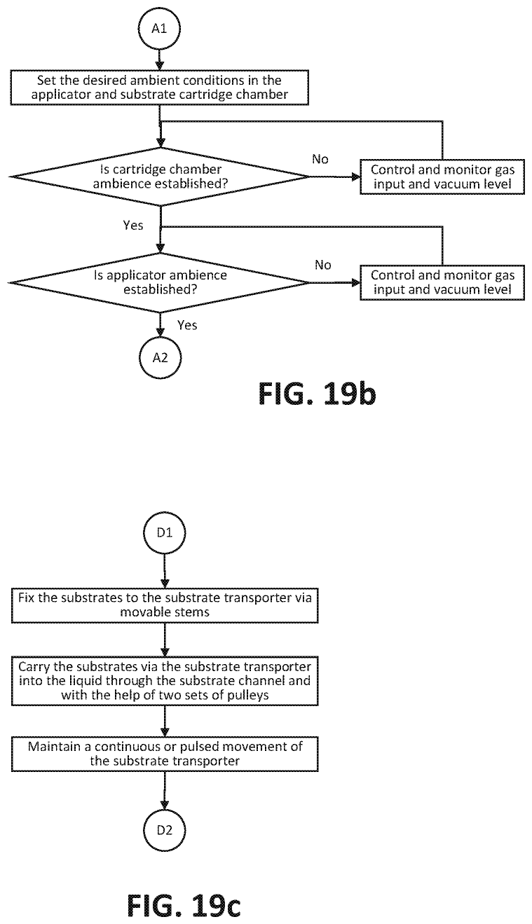

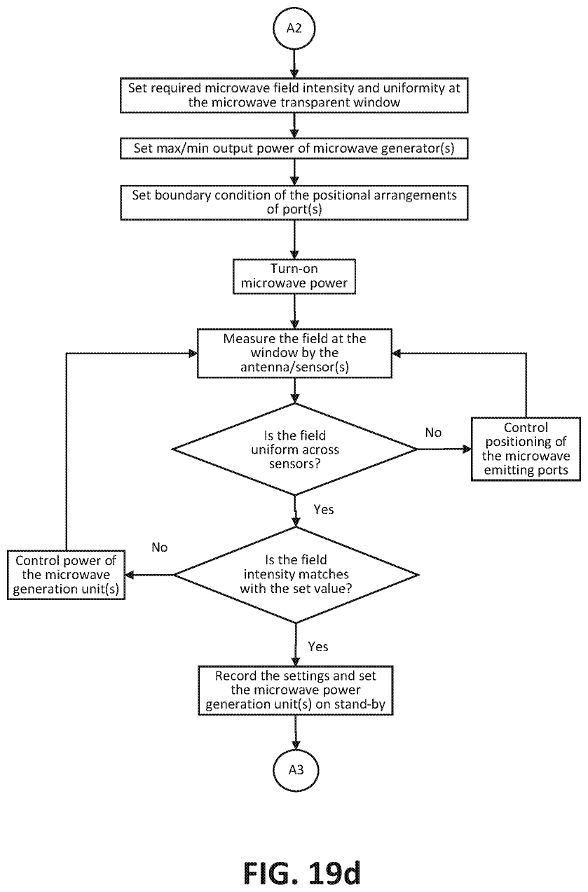

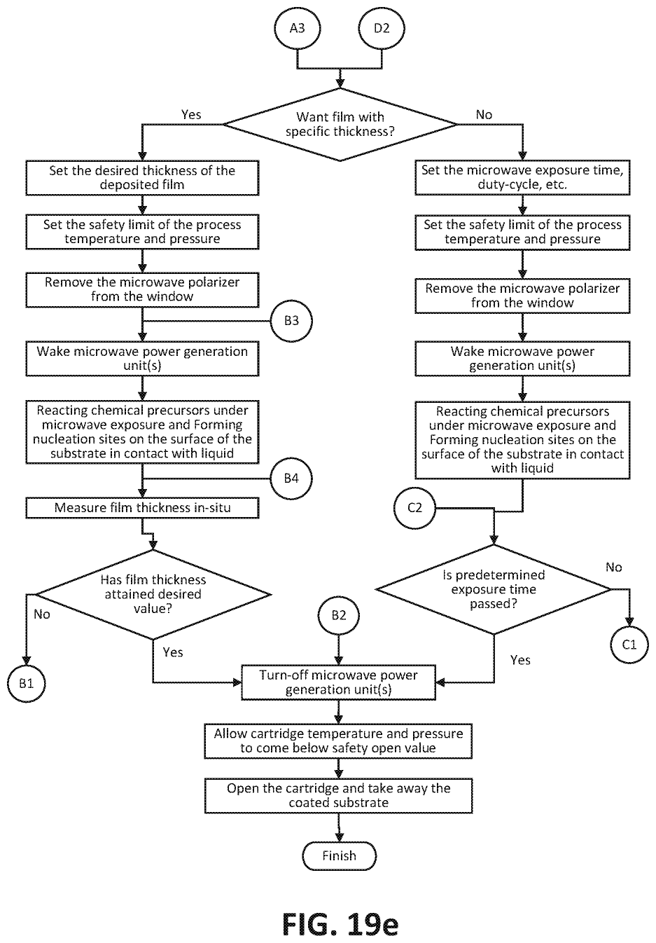

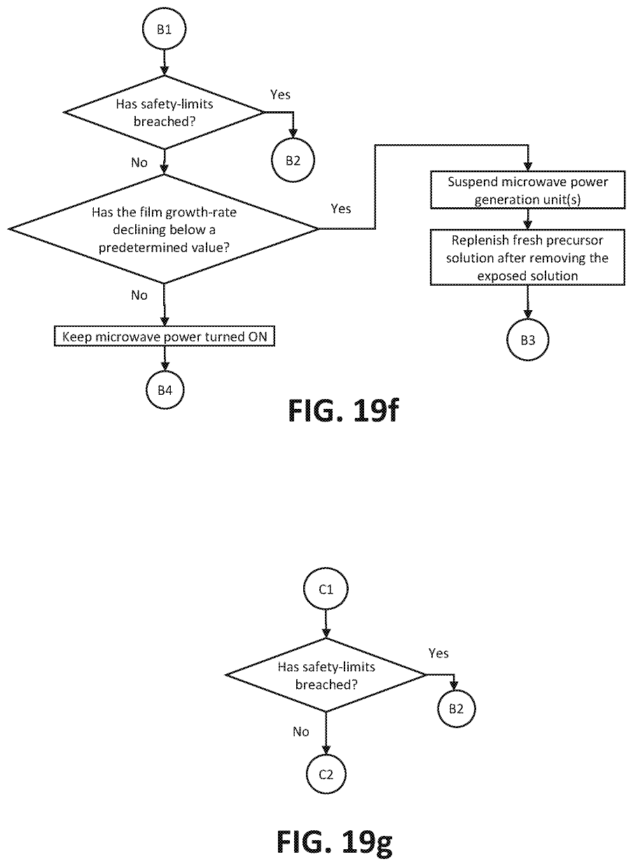

The preferred embodiments of a process for deposition of a film(s) on a substrate, under microwave-assisted conditions, are now described, by referring to FIGS. 19(a-g).

Initially, the apparatus, with the substrate cartridge chamber and the applicator, as described in the foregoing embodiments, is selected.

A reacting liquid with at least a chemical precursor and at least a solvent, is prepared. The preferred chemical precursor is selected from organic or inorganic metal salts. The preferable metal salts include a halide, a nitrate, an acetate and beta-diketonates of metals such as titanium (Ti), vanadium (V), chromium (Cr), manganese (Mn), iron (Fe), cobalt (Co), nickel (Ni), copper (Cu), zinc (Zn), barium (Ba), strontium (Sr), molybdenum (Mo), aluminum (Al), gallium (Ga) or indium (In). The inorganic salts include the halides, nitrates, acetates of the aforesaid metallic elements, whereas the organic salts include but not limited to the beta-diketonates such as acetylacetonates of the aforementioned metallic elements. The said precursors would be suitable for depositing thin films of oxides, in general, and binary, ternary, or quaternary oxides, such as ZnO, NiFe₂O₄, and YBa₂Cu₃O₇, respectively.

In a preferred aspect, the chemical precursors that are selected for the deposition of the film of the reacted product of the chemical precursors, are metal-organic compounds or inorganic salts of metals that are in the composition of the desired film. For example, the desired film could be of the oxide of the general formula AB₂O₄, wherein A is one of Mn, Ni, Co, Cu, Zn, Cr, Fe or a combination of these metals, whereas B is Fe, and O is oxygen. If B is Fe, AB₂O₄ would be a spinel ferrite. Other ferrite materials, having the general formula of AB₁₂O₁₉, wherein A is one of barium (Ba), strontium (Sr) or a combination of Ba, Sr, Co, Ti, Al, Zn, Zr, Sn, Ru, Mn, and B is Fe, and O is oxygen, can also be suitably deposited in thin film form.

If the thin film desired is that of a metal chalcogenide, suitable chemical precursors such as thio-beta-diketonates, are preferred, wherein the oxygen (O) in the beta-diketonate molecule is replaced with sulphur (S). Similarly for other chalcogens, namely, selenium (Se) and tellurium (Te). The chemical precursors can also be selected from a variety of metalorganic compounds with chalcogens in the molecular structure, considering their solubility in solvents appropriate for absorbing microwave energy.

In an exemplary aspect, in the present invention, metal organic chemical precursors are illustrated for use. It is also within the purview of this invention, to use other chemical precursors, such as inorganic salts for performing the deposition of films, under microwave irradiation.

The chemical precursors are mixed in a molar ratio based on the stoichiometric ratio of the metal ion content inside the desired end product, for instance oxides. In a preferred aspect, chemical precursors Zn(II)acetylacetonate and Fe(III)acetylacetonate are the metal complexes that are taken in molar proportions of 1:2 (0.5 mmol:1 mmol) ratio, and dissolved in a solvent mixture containing 1-decanol (25 ml) and ethanol (15 ml) to form the reacting liquid for a zinc ferrite (ZnFe₂O₄) film to be deposited on the substrate.

The solvents that are used in the process are polar, organic or aqueous solvents. The preferred polar solvents include water, methanol, ethanol, 2-propanol, butanol, octanol, 1-decanol, ethylene glycol, benzyl alcohol and dimethyl sulfoxide, or a combination of these solvents. Whereas, the preferred organic solvents include solvents having a short, long or a cyclic-carbon chain, such as methanol, 1-decanol, and benzyl alcohol respectively.

Aqueous solutions, such as ethanol-water mixture can also be used appropriately in the process steps of the present invention.

In the microwave-assisted film deposition process of the present invention, the selection of the preferred solvent is made by considering solvents having boiling points, in the range of about 70° C. (near the boiling point of the short-carbon-chain alcohol, methanol) to about 250° C. (near the boiling point of the long-carbon-chain alcohol, 1-decanol).

The selection of a preferred solvent(s) for the process steps of the present invention, controls the nominal temperature of the reacting liquid owing to their distinct boiling points, and thus the reaction mechanism leading to the formation of a film that is to be deposited on a substrate.

The reacting liquid thus prepared with the selected precursor(s) and solvent(s), is transferred into the microwave-transparent container of the substrate cartridge that is arranged in the substrate cartridge chamber. The microwave-transparent container is mounted or placed on the microwave-transparent window of the applicator. In this arrangement, the substrate that is to be deposited with the reaction product of the chemical precursors is physically separated from a microwave generating zone (applicator).

A suitable substrate is then selected for depositing a film from the reacted product of the selected chemical precursors. The material for the substrate is selected from materials such as electrical conductors, preferably copper (Cu), titanium (Ti), chromium (Cr), gold (Au), platinum (Pt), silver (Ag) and graphene, metal-alloys preferably titanium-alloy (TaN), copper-alloy and permalloy. The material can also be suitably selected from other materials such as semiconductors, preferably silicon (Si), germanium (Ge), gallium arsenide (GaAs), gallium nitride (GaN), indium phosphide (InP) and silicon carbide (SiC). In addition, electrical insulators such as aluminium oxide, fused quartz, silicate glass, polymer materials can also be used as substrate materials. A combination of above-mentioned materials can also be suitably adapted for use for the substrate such as Al-coated Silicon, Cu-coated fused quartz, or a layered stack of Cr and Au on a silica coated silicon wafer.

The selection of the substrate is made with a consideration that when the substrate is exposed to a microwave energy, the substrate absorbs the microwave energy depending on its dielectric characteristics and electrical conductivity and as a result, numerous discrete spots on the surface of the substrate may get energized and activated known as hotspots. These hotspots act as potential nucleation sites for the deposition of film from the reacted product of the chemical precursors in the liquid under the exposure of the microwave irradiation.

Once a desired substrate is selected, in the next step, the surface of the substrate on which the deposition of the film of the reacted product of the selected chemical precursors is to be performed, is also choses.

The selected substrate is placed under a removable lid of a substrate cartridge, in a facedown arrangement either by a vacuum suction mechanism or by a mechanical support configured to hold the substrate tightly (in a liquid-proof manner) to the removable lid. In the facedown arrangement, the face or surface of the substrate, which is to be deposited with the film is placed facing the liquid. In this step, the other side (or opposite side) of the substrate is used to connect the substrate to the removable lid of the substrate cartridge.

In the next step, liquid column height (h) of the reacting liquid in the microwave-transparent container is determined, while the placing the substrate in surface contact with the reacting liquid or immersing the substrate in the reacting liquid. In other words, the extent of thickness of the film that is required to be deposited on the substrate, determines the column height(h) of the reacting liquid depending on its dielectric properties, so that only the required portion of the substrate is exposed to reacting liquid. In an exemplary aspect, in the process steps of the present invention, the preferred liquid column height (h) is determined to be in the range of 1 mm to 50 cm for the aforementioned solvents under the purview of the present invention.

The removable lid with the substrate is then moved vertically towards the liquid that is present in the micro-wave transparent container, in accordance with the pre-determined liquid column height (h).

Alternately, in another preferred step, the liquid column height (h) can also be determined by varying the thickness of the removable lid as shown in FIG. 9a and FIG. 9b.

Once, the required portion of the substrate is in contact with the surface of the reacting liquid or immersed in the reacting liquid, the applicator and the substrate cartridge chamber are configured to obtain desired ambient conditions, by regulating the flow of gas(s) and monitoring vacuum levels. The desired ambience in the substrate cartridge chamber is deposition reaction specific and depends on the used precursors, solvents, substrates along with the process conditions like the operating temperature. The ambient is maintained for the applicator and the cartridge chamber, in the presence of a gas selected from air, oxygen, nitrogen, argon or a combination of these gases and at an operational pressure, in the range 1 mtorr to 1000 torr. The operational pressure is measured by a common pressure gauge that helps the gas injection and exhaust systems to monitor and maintain the ambient at a desired level

Subsequently, the step of propagating only a desired microwave field intensity, from the applicator, which is chosen depending on the requirements of the specific deposition process, into the substrate cartridge chamber, through the microwave transparent window of the applicator. The microwave field intensity that is permeating through the microwave transparent window, is selected to be in the range of 0 to 50 kV/m and is measured by the antenna element. The microwave radiation frequency is preferably 2.45 GHz or 915 MHz, and the output power of a microwave generation unit is in the range of 10 W to 5 kW.

The field intensity of the microwave energy is measured at the microwave-transparent window by the antenna element present as an embodiment of a metallic layer disposed underneath the microwave transparent window and this information is feedback to the central control monitoring unit, which in turn, controls the output power of the microwave generation units and the positions of the individual microwave ports of the array of ports in a iterative manner to attain the desired intensity of the microwave field.

When the reactant liquid is subjected to the desired microwave irradiation (say, field intensity of 10 kV/m, 2.45 GHz), the liquid gets heated. As the temperature of the liquid rises, the pressure in the cartridge (when there are no vents available on the substrate cartridge lid as shown in FIG. 1b) increases due to the elevated vapor pressure of the solvent (about 15 bar). This, in turn, raises the boiling point of the solvent, but not beyond 200° C. Under microwave irradiation and at elevated temperature and pressure, chemical reactions occur in the liquid, leading to the formation of the solid nanocrystallites (preferably of oxide materials), which is nucleated and eventually deposited on the immersed substrate. The process takes about 20 seconds to 1 hour depending on the choice of chemical precursors and solvents. It is found that, at the end of the process, the substrate is coated with a thin, uniform film (ranging in between 10 nm to 100 μm in thickness), wherein the crystallite size is about 5 nm (as deduced from electron microscopy shown in FIG. 23.

The nucleation sites formed on the depositing surface of the substrate are the key to obtain a smooth and strongly adherent film. The nucleation density is very high and is with a minimum of 1000 per μm² when the film with sufficient adherence is observed. FIG. 23 shows the nucleation site density of ˜1700 for a zinc ferrite film deposited on a Si (100) substrate.

The process steps of the present invention facilitate a rapid deposition, in the liquid medium, of the adherent oxide including but not limited to magnetic material (such as ferrite, or garnet) on a substrate, under microwave irradiation conditions and at a temperature in the range of 50° C. to 400° C., preferably about 200° C.

The process described in the present invention for the deposition of an oxide material on a substrate employs as precursors, metal-organic compounds that are non-toxic, dissolved in common alcohols, making the entire film deposition process environment-friendly.

In the film deposition process described in the present invention, appropriate chemical precursors and solvents are used to enable dipolar rotation of each solvent molecule in the electro-magnetic (EM) field of microwaves causes friction that leads to high local temperature within the reacting liquid. This results in the formation of the oxide material rapidly. As the entire solution is under the EM field, the formation of the oxide moieties, and their nucleation into small crystallites occurs, resulting in finely-structured oxide films on a substrate immersed in the solution.

In the process of the present invention, chemical reactions in the solution medium occur under conditions driven by kinetics of the reaction and away from thermodynamic equilibrium, leading to novel mechanical, electrical, magnetic, and optical properties in the resulting oxide materials, often in their nanometric form. One example is the formation of nanocrystalline zinc ferrite with significant room temperature magnetization. This is due to the far-from-equilibrium atomic arrangements inside the crystal structure of the materials, commonly known as partial crystallographic inversion, that occurs in the spinel structure of zinc ferrite, which occurs during the formation of the film under the said conditions.

The liquid is irradiated in the presence of the desired microwave field intensity resulting in the reaction of the chemical precursors, to form nucleation sites on the substrate, followed by the deposition of the reacted product of the chemical precursors, as a film, of a desired uniform thickness, composition and physical characteristics, on the surface of the substrate that is in contact with the liquid.

The substrate that is coated with the film from the substrate cartridge chamber is removed by lifting the removable lid.

The process provides alternative steps (as illustrated in the flowchart FIG. 19c) suitable for the deposition of film on multiple substrates at a time or on multiple substrate in a continuous batch processing as shown in FIG. 15.

The process also provides alternative steps to enable deposition of the film on the both sides of the substrate by altering the substrate holder attached to the substrate cartridge lid appropriately as shown in FIG. 11b.

The process also provides alternative steps to accommodate substrate with poor microwave absorbing capability by inserting an electrically conducting layer in between the substrate and the substrate cartridge lid as illustrated in FIG. 12a. The nature of the electrically conducting layer—such as the materials like Cu or Al or Fe, the thickness of the conducting layer (say, in the range of 20 nm to 1 mm; less than the skin-depth of the 2.45 GHz radiation in that given material), and the pattern (as shown in but not limited to FIG. 12b) of the conducting layer activates the substrate surface accordingly to enable the formation of nucleation sites.

The process also provides alternative steps to allow the deposition of the film in a gradient manner, i.e. with a gradient in film thickness by altering the geometry of the substrate cartridge lid appropriately as given in FIG. 10. The bottom surface of the substrate cartridge lid that holds the substrate is slanted by an angle, θ, in the range of 1° to 30° with respect to the horizontal plane.

The process also comprises the steps to deposit a film of desired thickness by an iterative close-loop control steps as illustrated in the flowchart FIG. 19f. An in situ thickness measurement probe provides the necessary feedback for the said process control.

The process comprises the steps to allow deposition process to continue under the irradiation of a constant or pulsed microwave field for a duration in the range of 10 s to 1 hr. to achieve a uniform or a less-uniform film.

The process comprises the steps to allow rotation of the substrate cartridge to ensure greater uniformity in the film thickness and composition. The speed of rotation of the substrate is in the range of 1 to 100 rpm and is managed by a gear assembly affixed to the stem disposed on the substrate cartridge lid.

The process comprises the steps to terminate the microwave irradiation when the safety limits of any set parameters are breached. The safety limit of the process temperature and pressure built inside the substrate cartridge are in the range of 25-400° C. and 50-300 psi respectively.

Accordingly, the microwave-assisted process for deposition of a film on a substrate, comprises the steps of: preparing the liquid of at least a chemical precursor and at least a solvent and transferring the liquid into the microwave-transparent container of the substrate cartridge that is disposed in the substrate cartridge chamber. The substrate is mounted with facedown on the removable lid of the substrate cartridge and is disposed to be in contact with the liquid at the preferred column height (h). The uniform microwave field of desired intensity that is achieved by a selected configuration of an array of ports, is propagated into the substrate cartridge chamber, through the entirety of the microwave transparent window of the applicator. The liquid is irradiated in the presence of the obtained microwave field intensity. The chemical precursors are reacted to form nucleation sites on the substrate, which is followed by the deposition of the reacted product of the chemical precursors, as a film, of a desired uniform thickness, composition and physical characteristics, on the surface of the substrate that is in contact with the liquid. The coated substrate is then removed from the substrate cartridge chamber.

In the process steps of the present invention, the at least chemical precursors is selected from metal salts and the metal salts are organic, inorganic or a combination thereof, preferably a halide, a nitrate, an acetate, a beta-diketonate or a thio-beta-diketonate of titanium (Ti), vanadium (V), chromium (Cr), manganese (Mn), iron (Fe), cobalt (Co), nickel (Ni), copper (Cu), zinc (Zn), barium (Ba), strontium (Sr), molybdenum (Mo), aluminum (Al), gallium (Ga) or indium (In).

The solvent for the process steps is selected from polar solvents, preferably, water, methanol, ethanol, 2-propanol, butanol, octanol, 1-decanol, ethylene glycol, benzyl alcohol and dimethyl sulfoxide.

In the process steps of the present invention, the substrate is metal-coated or a bare semiconductor, preferably of silicon (Si), germanium (Ge), gallium arsenide (GaAs), gallium nitride (GaN), indium phosphide (InP) and silicon carbide (SiC), Ga₂O₃, diamond or a bare or metal-coated electrical insulator, preferably aluminium oxide, fused quartz, MgO, glass or polymer materials.

The process according to the invention will now be illustrated by the Examples that follow. A skilled artisan will be aware that the examples are provided solely as an illustration and are not to be viewed as restrictive.

### Example 1

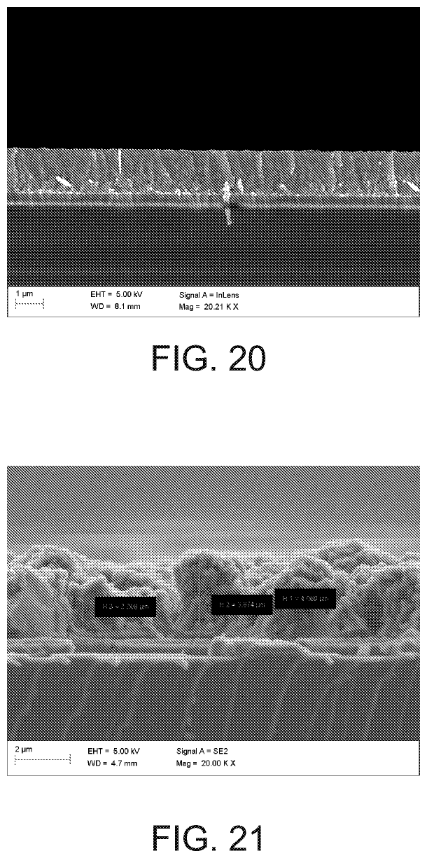

Chemical precursors (Zn(II)acetylacetonate and Fe(III)acetylacetonate) are the metal complexes that are taken in molar proportions of 1:2 (0.5 mmol:1 mmol) ratio and dissolved in a solvent mixture containing 1-decanol (25 ml) and ethanol (15 ml), to form a reacting liquid. The reacting liquid with the chemical precursors, is transferred into a microwave-transparent container of a substrate cartridge chamber, which is mounted on a microwave-transparent window of an applicator that is physically separated from the substrate cartridge chamber. A silicon wafer Si(100) 2 cm×2 cm size and having a thickness of 450 μm is selected as a substrate with a top layer of borophosphosilicate glass (BPSG) of 1 μm thickness. The substrate is detachably connected to a removable lid of a substrate cartridge and arranged in the substrate cartridge chamber by a vacuum chuck. The facedown portion of the substrate is immersed in the reacting liquid that is present in the microwave-transparent container. A safety limit is set for a temperature and a pressure, at 200° C. and 200 psi, respectively. The reacting liquid is then subjected to a uniform intensity of microwave irradiation obtained by keeping two microwave ports separated by 10 cm from each other and placed with zero vertical offset at a distance of 30 cm from the microwave transparent window, through the microwave transparent window of the applicator, with a desired intensity of the microwave field of 10 kV/m (±5%) from a microwave generation assembly operating at a frequency of 2.45 GHz, over the entire duration of the deposition process. Under the microwave irradiation and at an elevated temperature, the chemical precursors in the liquid undergo reaction, leading to formation of nucleation sites on the substrate and the deposition of zinc ferrite film. The zinc ferrite is deposited as a film, in a short period of time of 15 minutes, on the BPSG layer of the substrate, which is in contact with the liquid. The substrate with the deposited film, is taken out of the substrate cartridge chamber and subjected to scanning electron microscopy (SEM). A corresponding image of the cross-section of the coated film, as shown in FIG. 20, confirms the deposition of a uniform film of zinc ferrite with a thickness of 1.2 μm, on the substrate. It is also observed that the thickness of the zinc ferrite film is uniform with <2% variation, across the length and breadth of the substrate.

### Example 2

Chemical precursors (Ni(II)acetylacetonate and Fe(III)acetylacetonate) are taken in molar proportions of 1:2 (0.5 mmol:1 mmol) ratio, and dissolved in a solvent mixture containing 1-decanol (25 ml) and ethanol (15 ml) to form a reacting liquid. The reacting liquid with the chemical precursors, is transferred into a microwave-transparent container of a substrate cartridge chamber, which is mounted on a microwave-transparent window of an applicator that is physically separated from the substrate cartridge chamber. A silicon wafer Si(110) 2 cm×2 cm size and having a thickness of 450 μm is selected as a substrate. The substrate is detachably connected to a removable lid of a substrate cartridge and arranged in the substrate cartridge chamber. The facedown portion of the substrate is immersed in the reacting liquid that is present in the microwave-transparent container. A safety limit is set for a temperature and a pressure, at 200° C. and 200 psi, respectively. In contrast with the Example 1, the reacting liquid in this example, is subjected to a microwave irradiation of variable intensity, through the microwave transparent window of the applicator, with an output power varying between 0-300 W, from a microwave generation assembly, at an operating frequency of 2.45 GHz, over the entire duration of 15 minutes of the deposition process. The placement of the ports are maintained as optimized in the Example 1. Under this microwave irradiation condition and at an elevated temperature, the chemical precursors in the liquid undergo reaction, in a dynamic mode, with microwave power fluctuating in between 0-300 W, causing spatially non-homogenous nuclei formation, leading to the formation of a thick (˜3 to 4 μm) but a non-uniform film of nickel ferrite on the substrate, in a short period of time of 15 minutes. The substrate with the deposited film, is taken out of the substrate cartridge chamber and subjected to scanning electron microscopy (SEM). A corresponding image of the cross-section of the coated film, as shown in FIG. 21, confirms the deposition of a thick but non-uniform nickel ferrite film with a thickness of ˜3 to 4 μm.

### Example 3

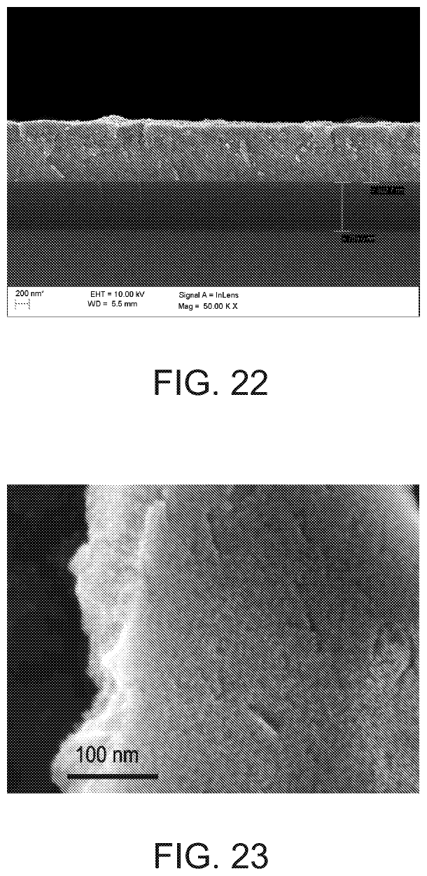

In this Example, a deposition of a thick and uniform film of a manganese-zinc ferrite, is illustrated, which is formed from a substitution of 50% of divalent zinc ions with divalent manganese ions. In order to obtain this reacted product, chemical precursors (Zn(II)acetylacetonate, Mn(II)acetylacetonate and Fe(III)acetylacetonate) are taken in molar proportions of 0.5:0.5:2 (0.25 mmol:0.25 mmol:1 mmol) ratio, and dissolved in a solvent mixture containing 1-decanol (25 ml) and ethanol (15 ml) to form a reacting liquid. The reacting liquid with the chemical precursors, is transferred into a microwave-transparent container of a substrate cartridge chamber, which is mounted on a microwave-transparent window of an applicator that is physically separated from the substrate cartridge chamber. A silicon wafer Si(100) having a thickness of 450 μm is selected as a substrate (4″ dia) with a top layer of borophosphosilicate glass (BPSG) of 1 μm thickness. A safety limit is set for a temperature and a pressure, at 200° C. and 200 psi, respectively. The reacting liquid is then subjected to a uniform intensity of microwave irradiation, through the microwave transparent window of the applicator, as described in Example 1, over the entire duration of the deposition process. Under the microwave irradiation and at an elevated temperature, the chemical precursors in the liquid undergo reaction, leading to the formation of leading to the formation of manganese-zinc ferrite nuclei, leading to the formation of manganese-zinc ferrite nuclei, which are deposited on the immersed substrate surface in contact with the liquid, forming a film, i.e., on the BPSG layer of the substrate, which is in contact with the liquid. The substrate with the deposited film, is taken out of the substrate cartridge chamber and subjected to scanning electron microscopy (SEM). A corresponding image of the cross-section of the coated film, as shown in FIG. 22, confirms the deposition of a thick and uniform film of manganese-zinc ferrite with a thickness of 0.8 μm, on the substrate.

### Example 4

In this Example, the substrate-film interface side of a zinc ferrite film, as obtained from Example 1, is scratched out and probed to demonstrate nucleation site density of the deposited film on the substrate. A high-resolution SEM (HRSEM) image of the surface of the film is shown in FIG. 23. The HRSEM image of the film surface, depicts the presence of numerous small spherical particles of less than 5 nm in extension, which act as the initial nuclei on the substrate, leading eventually to the formation of the film. The density of the nuclei is determined to be ˜1500 per μm².

### Example 5

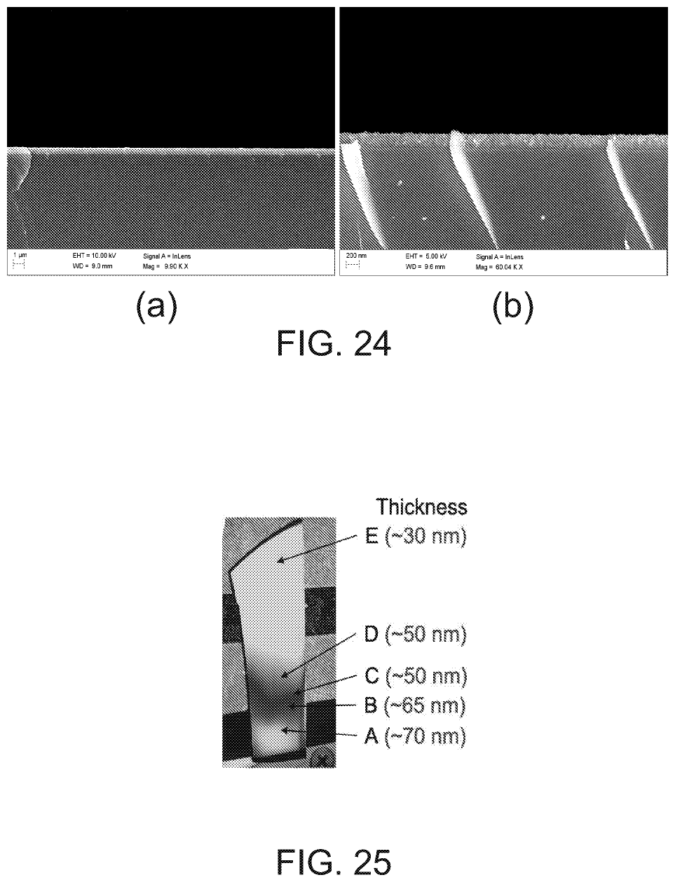

In this Example, as shown in FIG. 24, a deposition of a smooth and uniform film of zinc ferrite, as described in Example 1, with a specific thickness of 840 nm, on a Si (100) substrate, by monitoring the film thickness in situ, by an IR probe, and controlling the duration of microwave irradiation such that the desired film thickness of 840 nm is achieved. The intended thickness of the deposited film is 1000 nm indicating ˜15% error in the thickness measurement. On the other hand, in another example, a smooth and uniform film of nickel ferrite is deposited as per the precursor recipe described in Example 2, but as per the optimization of the microwave field as described in Example 1) by monitoring the film thickness by using a visible light probe and the process conditions are controlled so as to obtain a film of a desired thickness of 200 nm. The actual thickness of the film turns out to be ˜210 nm, indicating an error of less than 10%.

### Example 6

The microwave field intensity impinging on the substrate has an important role in the formation of the nucleation sites and thus to determine the film thickness and film surface morphology. Therefore, the dielectric characteristic of the reacting liquid column between the substrate and the microwave transparent window plays a huge role as it screens the microwave field intensity. In this example, as shown in FIG. 25, a substantially rectangular (3 cm×1 cm) piece of Si (100) substrate is placed at a slanting angle of 10° with respect to a horizontal plane, while immersed inside a reacting liquid, to achieve the deposition of zinc ferrite film as described in Example 1. The liquid is irradiated by microwave with constant power of 300 W (microwave frequency=2.45 GHz) for just 2 min. In this Example, the height (h) of the liquid column below the substrate is varied gradually, from one edge of the substrate to the other edge, along the length of the substrate. In this Example, the substrate is kept slanted at an angle with respect to the horizontal, resulting in the situation of having the substrate at two different ‘h’ values. A “thinner” liquid column results in a better penetration of the microwave field into the liquid which, in turn, promotes rapid formation of nuclei leading to the growth of a thicker film (i.e., a higher film growth rate). By contrast, at the same time, a thinner film is formed on that portion of the substrate beneath which lies a “thicker” liquid column.

### Example 7

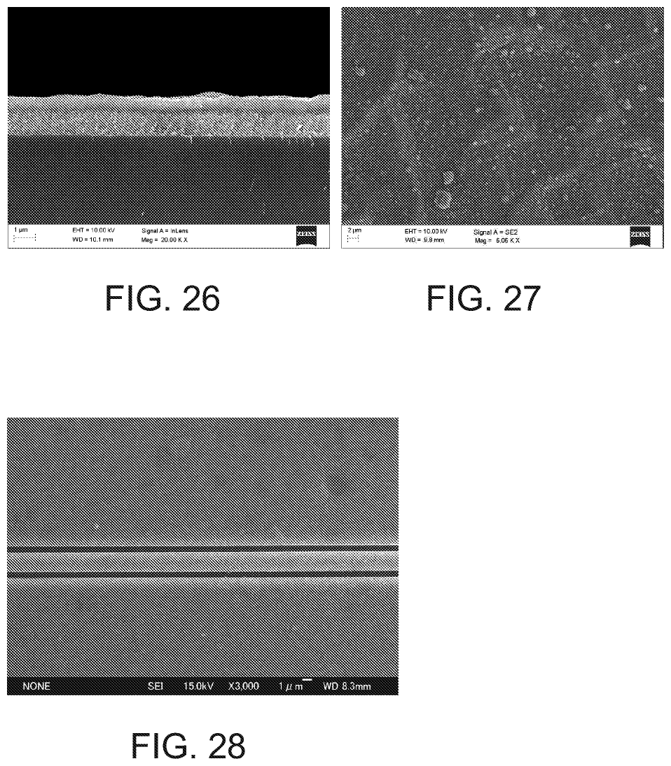

In this example, as shown in FIG. 26, two visibly distinct but chemically homogenous layers of zinc ferrite films are deposited in two different steps. Initially, a reaction liquid is prepared by mixing chemical precursors (Zn(II)acetylacetonate and Fe(III)acetylacetonate), in molar proportions of 1:2 (0.2 mmol:0.4 mmol), in a solvent mixture containing 1-decanol (7 ml) and ethanol (3 ml). The reacting liquid with the chemical precursors, is transferred into a microwave-transparent container of a substrate cartridge chamber, which is mounted on a microwave-transparent window of an applicator that is physically separated from the substrate cartridge chamber. A silicon wafer Si(100) (3 cm×1 cm; 450 μm thick) is selected as a substrate. The substrate is detachably connected to a removable lid of a substrate cartridge and arranged in the substrate cartridge chamber. The facedown portion of the substrate is immersed in the reacting liquid that is present in the microwave-transparent container. The reacting liquid is then subjected to a constant intensity of microwave irradiation, for 30 minutes, through the microwave transparent window of the applicator, with an output power of 300 W from a microwave generation assembly operating at a frequency of 2.45 GHz, over the entire duration of the deposition process. In the next step, when the growth rate of the film recedes, a replacement of the reaction liquid in microwave-transparent container is performed, by lifting the removable lid of the cartridge along with the substrate. The substrate is immersed in the fresh reaction liquid by bringing down the removable lid again. The substrate and the liquid are irradiated again with a similar microwave power. The substrate that is deposited with the films, in two steps of irradiation, is taken out of the substrate cartridge chamber and subjected to scanning electron microscopy (SEM). A corresponding image of the cross-section of the coated film, as shown in FIG. 26, depicts a resultant total thickness 1.7 μm i.e., the thickness of 1 μm that is obtained from the first irradiation step and the thickness of 0.7 μm that is obtained from the second irradiation step.

### Example 8

In another example, nickel ferrite film is deposited on the backside of a Si (100) substrate (as shown in FIG. 27) simultaneously with the front side of the substrate (as explained in the aforementioned Example 2 of this present invention) by using a substrate holder 105a3 designated to enable deposition on both sides of a substrate. A 2 cm×2 cm silicon substrate of 450 μm thickness is used as the substrate. The substrate is affixed to the holder using a couple of grooves present on the holder designed to hold the substrates tightly. The deposited backside film is spread all over the substrate and is of similar morphological and chemical characteristics as that of the front side film.

### Example 9

Following the deposition process as described in Example 1, zinc ferrite film was deposited on a silicon-chip obtained from a foundry (size: 2.5×2.5 mm). The top layer of the chip is made up of polymer material, 2 μm thick polyamide, known as the passivation layer and a well-known microwave transparent material. Underneath this polyamide layer, a patterned metal (0.8 μm thick Al) layer is present. The spacings between two metal strips are filled by silicate glass. FIG. 28 shows the zinc ferrite film deposited selectively on the polyamide surface where metal patterns are present under it. This example proves the deposition of a film on a polymer substrate as well as the effect of having a electrically conductive layer behind a microwave transparent substrate such as polyamide.

### Advantages of the Present Invention

The present invention provides an apparatus and method to deposit thin films of a variety of materials (on a substrate) under clean conditions because the microwave-transparent window of the present invention allows separation of the film deposition chamber from the microwave cavity in the microwave-assisted chemical process in the liquid (solution) medium.

In the present invention, by using a face-down configuration of the substrate (relative to microwave energy source), the present invention sets up an appropriate temperature and nucleation density gradients in the said liquid, creating conditions for the deposition of adherent films on the substrate.

The liquid-based process of the present invention obviates the need for expensive equipment needed to create and maintain high vacuum conditions typically used in thin film deposition.

The liquid-based process of the present invention yields crystalline films as deposited, thereby preventing the need for post-deposition annealing (processing) or deposition at a high substrate temperature that is usually required in other methods of film deposition. Thus, the present invention provides a clean, CMOS-compatible method and process for film deposition. The process and method are also advantageous wherever film deposition at low temperature is desired, for example, when the substrate is made of a polymer with a low melting point.

The apparatus and method of the present invention provide a method to obtain a film of uniform thickness and composition by adjusting conditions for the uniform intensity of the microwave field in the film deposition zone.

The present invention provides an apparatus and method to deposition of film on both sides of a (flat) substrate.

The present invention provides an apparatus and a method to deposit a film with deliberately chosen non-uniformity in thickness and composition across a substrate.

The present invention provides a means to monitor and control the thickness of the thin film being deposited, in the liquid-based reactive deposition.

The (same) aforesaid means for controlling and monitoring permits the monitoring of the liquid (solution) in such a way as to ensure film deposition of repeated high quality.

In the present invention, by providing for substrate rotation during microwave irradiation of the solution, the invention enables the deposition of films with uniform thickness and composition.

In the present invention, by using non-toxic chemical precursors dissolved in non-toxic solvents, the invention provides an environment-friendly method and process for film deposition.

In the present invention, by permitting the use of appropriate non-toxic chemical precursors dissolved in non-toxic solvents, the present invention provides for the deposition of thin films of a wide variety of materials, including oxides and chalcogenides.

The present invention also provides an apparatus and method for the “batch processing” of deposition on substrates in a “conveyor belt-like” fashion.

The apparatus, method, and process of the present invention provide comprehensive controls to enable the successful deposition of high-quality thin films, in both the single-wafer and batch-processing modes.

We claim:

1. A microwave-assisted apparatus (100) for deposition of a film on a substrate, comprising:
(i) an applicator (101) with a microwave-transparent window (109) and an array of ports (103) disposed at an intervening distance ‘d’ from the microwave-transparent window (109), to receive a microwave energy from microwave generating units (103a);
(ii) a substrate cartridge chamber (110) with a removable cover (110a) mounted on the applicator (101);
(iii) a cartridge (105) including a microwave-transparent container (105b) with a removable lid (105a) and a stem (106), removably disposed in the substrate cartridge chamber (110) and the stem (106) being connected to the removable cover (110a);
(iv) the microwave-transparent container (105b) configured to store a liquid (107) with chemical precursors and the liquid (107) is disposed to get irradiated with a uniform microwave field intensity that is propagated through the entirety of the microwave-transparent window (109), to cause the chemical precursors to undergo microwave-assisted reaction; and
(v) a substrate (104) detachably connected to the removable lid (105a) and its facedown portion configured to be in contact with the irradiated liquid (107), for a deposition of the reacted product of the chemical precursors, as a film (119), on the surface of the substrate (104).

2. The apparatus (100) as claimed in claim 1, wherein the material for the microwave-transparent window (109) is a fused quartz, polytetrafluoroethylene (PTFE) or a single crystal aluminium oxide (Al₂O₃).

3. The apparatus (100) as claimed in claim 1, wherein vents (108) are disposed on the removable lid (105a).

4. The apparatus (100) as claimed in claim 1, wherein the cartridge (105) is disposed in the applicator (101).

5. The apparatus (100) as claimed in claim 1, wherein the ports (103) as an array are horizontal and offset to a base plane (111) and are disposed symmetrical or asymmetrical to a central axis (112) of the microwave-transparent window (109).

6. The apparatus (100) as claimed in claim 1, wherein gas injection and vacuum channels (113, 114, 115, 116) are connected to the applicator (101) and the substrate chamber (110), respectively.

7. The apparatus (100) as claimed in claim 1, wherein a probe (120) to monitor liquid characteristics in the microwave-transparent container (109) and the growth of the film (119) on the substrate (104), is disposed in the applicator (101) and in the substrate chamber (110) and the probe (120) is a transmitter-receiver assembly, selected from infrared (IR), ultraviolet (UV), visible light (V) and ultrasonic devices.

8. The apparatus (100) as claimed in claim 1, wherein upper and side portions of the walls (121) of the substrate cartridge chamber (110) are coated with a microwave-absorbing material, preferably with silicon carbide (SiC) or strontium hexaferrite (SrFe₁₂O₁₉).

9. The apparatus (100) as claimed in claim 1, wherein a dual-motion actuator (123) is connected to the stem (106) of the cartridge (105) and the cartridge (105) is configured to rotate about a vertical axis (112) and move vertically with respect to the base plane (111).

10. The apparatus (100) as claimed in claim 1, wherein the removable lid (105a) and the microwave-transparent container (105b) are disposed to rotate reciprocally and differentially.

11. The apparatus (100) as claimed in claim 1, wherein the substrate (104) is disposed to be immersed in the liquid (107).

12. The apparatus (100) as claimed in claim 1, wherein the removable lid (105a) is of variable thickness.

13. The apparatus (100) as claimed in claim 1, wherein the bottom surface of the removable lid (105a) is with a gradient profile (105a2), and the gradient profile is at an inclination angle, in the range of 1-30 degree from the base plane (111).

14. The apparatus (100) as claimed in claim 1, wherein a holder (105a3) is connected to the removable lid (105a) and is made of a microwave-transparent material, preferably a fused quartz or polytetrafluoroethylene (PTFE).

15. The apparatus (100) as claimed in claim 1, wherein an electrically conducting layer (117) is disposed between the removable lid (105a) and the substrate (104) and the electrically conducting layer (117) is continuous or patterned.

16. The apparatus as claimed in claim 1, wherein a metallic layer (118) is connected to the microwave-transparent window (109) facing an inner portion of the applicator (101) and is configured as a polarizer and an antenna (118a).

17. The apparatus (100) as claimed in claim 1, wherein the microwave-transparent container (105b) is disposed in lieu of the microwave-transparent window (109).

18. The apparatus (100) as claimed in claim 1, wherein the material for the substrate (104) is selected from metal, a metallic alloy, a semiconductor or an insulator.

19. The apparatus (100) as claimed in claim 1, wherein the size of the substrate (104) is in the range of 1-2000 cm².

20. The apparatus (100) as claimed in claim 1, wherein the average surface roughness of the film is in the range 1-50 nm and the thickness in the range of 10 nm to 100 μm.

21. The apparatus as claimed in claim 1, wherein the substrate (104) is configured to rotate at a speed in the range of 1 to 100 rpm.

22. An apparatus (200) for deposition of thin films and coatings on substrates, comprising:
(i) an applicator (201) with a microwave-transparent window (209) and an array of ports (203) disposed at an intervening distance ‘d’ from the microwave-transparent window (209), to receive a microwave energy from a microwave generating unit (203a);
(ii) a microwave-transparent container (205b) with a removable lid (205a) mounted on the applicator (201); the microwave-transparent container (205b) being configured to store a liquid (207) with chemical precursors and the liquid (207) being configured to get irradiated with a uniform microwave field intensity that is propagated through the entirety of the microwave-transparent window (209), to cause the chemical precursors to undergo microwave-irradiated reaction;
(iii) a removable lid (205a) operable by plungers (212) connected to the microwave-transparent container (205b);
(iv) substrate channels (210, 211) disposed between the inner portion of the removable lid (205a) and an upper portion of the microwave-transparent container (205b);
(v) a first set of pulleys (208a) connected to the removable lid (205a) and a second set of pulleys (208a) disposed inside the microwave transparent container (205b);
(vi) a looped substrate transporter (208) disposed to be in movable contact with the first and second pulleys (208a);
(vii) movable stems (206) connected to the looped substrate transporter (208) and configured to make ingress into and egress out of the microwave transparent container (205b), through the substrate channels (210, 211); and
(viii) the substrates (204) detachably connected to the movable stems (206) and their facedown portions being disposed to be in contact with the irradiated liquid (207), for a deposition of the reacted product of the chemical precursors, as a film, on the surface of the substrate (204) that is in contact with the liquid (207).

23. The apparatus (200) as claimed in claim 22, wherein an inlet (214) and an outlet (215) with valves (216) are connected to the microwave transparent container (205b).

24. The apparatus (200) as claimed in claim 22, wherein a probe (220) to monitor liquid characteristics in the the microwave-transparent container (205b) and the growth of the film (119), is disposed in the applicator (201) and in the microwave-transparent container (205b) and the probe (220) is a transmitter-receiver assembly that is selected from infrared (IR), ultraviolet (UV), visible light (V) and ultrasonic devices.

25. The apparatus as claimed in claim 22, wherein the substrates (204) are of same or different geometrical shapes.

26. The apparatus (200) as claimed in claim 22, wherein the size of the substrate (204) is in the range of 1-2000 cm².

27. A system (300) for deposition of a film on a substrate, comprising:
(i) an applicator (301) with a microwave-transparent window (309) and an array of ports (303), disposed at an intervening distance ‘d’ from the microwave-transparent window (309), to receive a microwave energy from a microwave generating unit (303a);
(ii) a substrate cartridge chamber (310) mounted on the applicator (301); a cartridge (305) including a microwave-transparent container (305b) with a removable lid (305a) and a stem (306) being removably disposed in the substrate cartridge chamber (310); the microwave-transparent container (305b) being configured to store a liquid (307) with chemical precursors and the liquid (307) is configured to get irradiated with a uniform microwave field intensity that is propagated through the entirety of the microwave-transparent window (109), to cause the chemical precursors to undergo microwave-irradiated reaction; a substrate (304) detachably connected to the removable lid (305a) and its facedown portion is configured to be in contact with the irradiated liquid (307), for a deposition of the reacted product of the chemical precursors, as a film (319), on the surface of the substrate (304) that is in contact with the liquid (307);
(iii) microwave energy generating units (330) connected to the ports (303) through waveguides (329);
(iv) probes (320) disposed in the applicator (301) and in the substrate cartridge chamber (310) and being connected to a probe management unit (331);
(v) gas injection and vacuum control units (327, 328) connected to the substrate cartridge chamber (310) and the applicator (301) through gas and vacuum inlets (315, 313) respectively;
(vi) a stem movement control unit (322) connected to a stem (306) through a dual-motion actuator (323); and
(vii) a central control monitoring unit (332) operably connected to the microwave energy generating units (330) and configured to regulate the microwave energy and port positions; the central control monitoring unit (332) being operably connected to an electrically conducting layer (318) and configured to measure a field intensity of the microwave energy, the central control monitoring unit (332) being operably connected to the gas injection and vacuum control units (327, 328) and configured to control the ambient of the applicator (301) and the substrate cartridge chamber (310), the central control monitoring unit (332) being operably connected to the stem movement control unit (322) and is configured to control the movement of the cartridge (305) including the microwave-transparent container (305b) with the removable lid (305a) and the stem (306), substrate (304) and the liquid (307), the central control monitoring unit (332) being operably connected to the probe management unit (331) and configured to probe the liquid characteristics and the film growth.

28. The system as claimed in claim 27, wherein the probes (320) are transmitter-receiver assemblies that are selected from infrared (IR), ultraviolet (UV), visible light (V) and ultrasonic devices.

29. The system as claimed in claim 27, wherein the microwave energy generating units (330) are solid state MGUs.

30. A microwave-assisted process for deposition of a film on a substrate, comprising the steps of:
(i) preparing a liquid of at least a chemical precursor and at least a solvent and transferring the liquid into a microwave-transparent container of a substrate cartridge disposed in a substrate cartridge chamber;
(ii) mounting a substrate with facedown on a removable lid of the substrate cartridge and disposed to be in contact with the liquid at a preferred column height (h);
(iii) propagating only a uniform microwave field of desired intensity that is achieved by a selected configuration of an array of ports, into the substrate cartridge chamber, through the entirety of the microwave transparent window of an applicator;
(v) irradiating the liquid in the presence of the obtained microwave field intensity;
(vi) reacting the chemical precursors to form nucleation sites on the substrate, followed by the deposition of the reacted product of the chemical precursors, as a film, of a desired uniform thickness, composition and physical characteristics, on a surface of the substrate that is in contact with the liquid; and
(viii) removing the substrate with the film from the substrate cartridge chamber.

31. The process as claimed in claim 30, wherein the at least chemical precursors is selected from metal salts and the metal salts are organic, inorganic or a combination thereof, preferably a halide, a nitrate, an acetate, a beta-diketonate or a thio-beta-diketonate of titanium (Ti), vanadium (V), chromium (Cr), manganese (Mn), iron (Fe), cobalt (Co), nickel (Ni), copper (Cu), zinc (Zn), barium (Ba), strontium (Sr), molybdenum (Mo), aluminum (Al), gallium (Ga) or indium (In).

32. The process as claimed in claim 30, wherein the at least solvent is selected from polar solvents, preferably, water, methanol, ethanol, 2-propanol, butanol, octanol, 1-decanol, ethylene glycol, benzyl alcohol and dimethyl sulfoxide.

33. The process as claimed in claim 30, wherein the substrate is metal-coated or a bare semiconductor, preferably of silicon (Si), germanium (Ge), gallium arsenide (GaAs), gallium nitride (GaN), indium phosphide (InP) and silicon carbide (SiC), Ga₂O₃, diamond or a bare or metal-coated electrical insulator, preferably aluminium oxide, fused quartz, MgO, glass or polymer materials.

34. The process as claimed in claim 30, wherein the liquid column height(h) is in the range of 1 mm to 50 cm.

35. The process as claimed in claim 30, wherein the ambient for the applicator and the cartridge chamber is air, oxygen, nitrogen, argon or a combination thereof and the operational pressure is in the range 1 mtorr to 1000 torr.

36. The process as claimed in claim 30, wherein the microwave field intensity permeating through the microwave transparent window is in the range of 0 to 50 kV/m.

37. The process as claimed in claim 30, wherein the microwave radiation frequency is preferably 2.45 GHz or 915 MHz, and the output power of the microwave generation unit is in the range of 10 W to 5 kW.

38. The process as claimed in claim 30, wherein the nucleation density is with a minimum of 1000 per μm².
